(19) United States
(12) Patent Application Publication
(10) Pub. No.: US 2025/0006905 A1
(43) Pub. Date: Jan. 2, 2025

(54) SECONDARY BATTERY

(71) Applicant: MURATA MANUFACTURING CO., LTD., Kyoto (JP)

(72) Inventors: Yukihiro KATOU, Kyoto (JP); Akiko NAGAHARA, Kyoto (JP); Hideki NAKAI, Kyoto (JP)

(21) Appl. No.: 18/753,568

(22) Filed: Jun. 25, 2024

(30) Foreign Application Priority Data
Jun. 28, 2023 (JP) 2023-106192

(51) Int. Cl. H01M 4/36; H01M 4/02; H01M 4/525; H01M 4/58; H01M 10/0525; H01M 10/0563

(52) U.S. Cl. CPC H01M 4/366; H01M 4/525; H01M 4/58; H01M 10/0525; H01M 10/0563; H01M 2004/028

(57) ABSTRACT

A secondary battery is provided and includes a positive electrode including a positive electrode active material layer, a negative electrode, and an electrolytic solution including an electrolyte salt. The positive electrode active material layer includes a plurality of positive electrode active material particles, and the positive electrode active material particles each include a central portion including a lithium composite oxide and a covering portion provided on a surface of the central portion. The lithium composite oxide has a crystal structure of a layered rock salt type and includes lithium, nickel, and other elements as constituent elements. The covering portion includes lithium, fluorine, boron, and oxygen as constituent elements. The electrolyte salt includes a fluorine-containing lithium salt. When a sum of a content of the nickel in the lithium composite oxide and a content of the other elements in the lithium composite oxide is taken as 100 parts by mol, the content of the nickel in the lithium composite oxide is 80 parts by mol or more and 100 parts by mol or less. A first negative secondary ion derived from LiF₂⁻ and a second negative secondary ion derived from BO₂⁻ are detected in analysis in a depth direction of the positive electrode active material layer using time-of-flight secondary ion mass spectrometry. A change in ionic strength of the first negative secondary ion in the depth direction has a first peak, and a change in ionic strength of the second negative secondary ion in the depth direction has a second peak. The second peak is located on a deeper side than the first peak in the depth direction.

### CROSS REFERENCE TO RELATED APPLICATIONS

The present application claims priority to Japanese patent application no. 2023-106192, filed on Jun. 28, 2023, the entire contents of which are incorporated herein by reference.

### BACKGROUND

The present technology relates to a secondary battery.

Since various electronic devices such as mobile phones have been widely used, a secondary battery, which is smaller in size and lighter in weight and allows for a higher energy density, is under development as a power source. The secondary battery includes a positive electrode, a negative electrode, and an electrolytic solution, and various considerations have been given to the configuration of the secondary battery.

Specifically, a coating portion is formed on surfaces of lithium composite transition metal oxide particles containing nickel, and the coating portion contains fluorine. A high concentration of fluorine is present on surfaces of composite oxide particles containing nickel. A positive electrode active material contains a lithium transition metal oxide, and a peak derived from boron is detected in a depth direction of the positive electrode active material by time-of-flight secondary ion mass spectrometry. By charging and discharging the assembled battery under heating, ions such as lithium borate ions are detected in surface analysis of a negative electrode active material after initial charging and discharging using time-of-flight secondary ion mass spectrometry.

### SUMMARY

The present technology relates to a secondary battery.

Various studies on the configuration of the secondary battery have been made, but the safety of the secondary battery is still insufficient, and therefore there is room for improvement.

A secondary battery capable of obtaining excellent safety is desired.

A secondary battery according to an embodiment of the present technology includes a positive electrode including a positive electrode active material layer, a negative electrode, and an electrolytic solution containing an electrolyte salt. The positive electrode active material layer contains a plurality of positive electrode active material particles, and the positive electrode active material particles each include a central portion containing a lithium composite oxide and a covering portion provided on a surface of the central portion. The lithium composite oxide has a crystal structure of a layered rock salt type and contains lithium, nickel, and other elements as constituent elements. The covering portion contains lithium, fluorine, boron, and oxygen as constituent elements. The electrolyte salt contains a fluorine-containing lithium salt. When a sum of a content of the nickel in the lithium composite oxide and a content of the other elements in the lithium composite oxide is taken as 100 parts by mol, the content of the nickel in the lithium composite oxide is 80 parts by mol or more and 100 parts by mol or less. A first negative secondary ion derived from LiF₂⁻ and a second negative secondary ion derived from BO₂⁻ are detected in analysis in a depth direction of the positive electrode active material layer using time-of-flight secondary ion mass spectrometry. A change in ionic strength of the first negative secondary ion in the depth direction has a first peak, and a change in ionic strength of the second negative secondary ion in the depth direction has a second peak. The second peak is located on a deeper side than the first peak in the depth direction.

Here, as described above, the lithium composite oxide is a generic term for oxides having a crystal structure of a layered rock salt type and containing lithium, nickel, and other elements as constituent elements, and the other elements are any one kind or two or more kinds of elements other than lithium and nickel. The fluorine-containing lithium salt is a generic term for lithium salts containing fluorine as a constituent element. The detailed configurations of the lithium composite oxide and the fluorine-containing lithium salt will be described later.

According to the secondary battery of an embodiment of the present technology, the positive electrode active material layer of the positive electrode contains a plurality of positive electrode active material particles, the positive electrode active material particles each include a central portion and a covering portion, the central portion contains a lithium composite oxide, the lithium composite oxide has a crystal structure of a layered rock salt type and contains lithium, nickel, and other elements as constituent elements, the covering portion contains lithium, fluorine, boron, and oxygen as constituent elements, the electrolyte salt of the electrolytic solution contains a fluorine-containing lithium salt, a content of nickel in the lithium composite oxide is 80 parts by mol or more and 100 parts by mol or less, a first negative secondary ion derived from LiF₂⁻ and a second negative secondary ion derived from BO₂⁻ are detected in analysis in a depth direction of the positive electrode active material layer using time-of-flight secondary ion mass spectrometry, and a second peak in a change in ionic strength of the second negative secondary ion is located on a deeper side than a first peak in a change in ionic strength of the first negative secondary ion, so that excellent safety can be obtained.

The effect of the present technology is not necessarily limited to the effect described here, and may be any effect of a series of effects including relating to the present technology described later.

### BRIEF DESCRIPTION OF THE FIGURES

FIG. 1 is a perspective view illustrating the configuration of a secondary battery in an embodiment of the present technology;

FIG. 2 is a sectional view illustrating the configuration of a battery element illustrated in FIG. 1;

FIG. 3 is a sectional view illustrating the configuration of a positive electrode active material particle;

FIG. 4 is a sectional view schematically illustrating the configuration of positive electrode active material particles illustrated in FIG. 3;

FIG. 5 shows an example of an analysis result in a depth direction of a positive electrode active material layer using time-of-flight secondary ion mass spectrometry;

FIG. 6 shows another example of the analysis result in the depth direction of the positive electrode active material layer using time-of-flight secondary ion mass spectrometry;

FIG. 7 is a sectional view for explaining a method for manufacturing a secondary battery; and

FIG. 8 is a sectional view illustrating the configuration of a secondary battery for a test.

### DETAILED DESCRIPTION

The present technology will be described in further detail below including referring to the accompanying drawings according to an embodiment.

First, a secondary battery of an embodiment of the present technology will be described.

The secondary battery described herein is a secondary battery that can obtain a battery capacity by utilizing occlusion and release of an electrode reactant and includes a positive electrode, a negative electrode, and an electrolytic solution.

A charge capacity of the negative electrode is preferably larger than a discharge capacity of the positive electrode. That is, an electrochemical capacity per unit area of the negative electrode is preferably larger than an electrochemical capacity per unit area of the positive electrode. This is to suppress the electrode reactant from precipitating on the surface of the negative electrode during charging.

The type of the electrode reactant is not particularly limited, but is specifically a light metal such as an alkali metal or an alkaline earth metal. Specific examples of the alkali metal include lithium, sodium, and potassium, and specific examples of the alkaline earth metal include beryllium, magnesium, and calcium.

In the following, a description is given of an example case where the electrode reactant is lithium. A secondary battery in which the battery capacity is attained by utilizing occlusion and release of lithium is a so-called lithium ion secondary battery. In the lithium ion secondary battery, lithium is occluded and released in an ionic state.

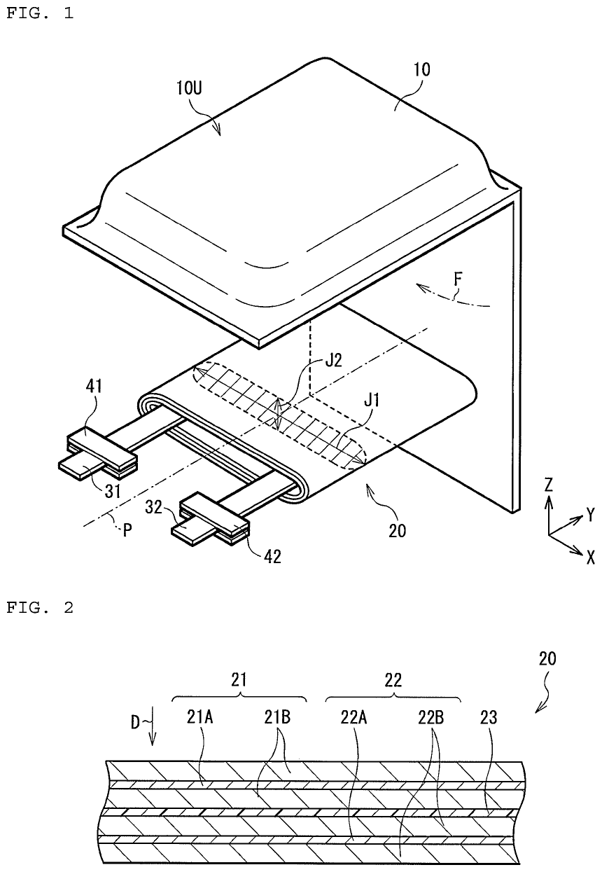

FIG. 1 illustrates a perspective configuration of a secondary battery. FIG. 2 illustrates a sectional configuration of a battery element 20 illustrated in FIG. 1. FIG. 3 illustrates a sectional configuration of a positive electrode active material particle 210.

However, in FIG. 1, a state where an exterior film 10 and the battery element 20 are separated from each other is illustrated, and a sectional surface of the battery element 20 along XZ plane is indicated by a broken line. FIG. 2 illustrates only a part of the battery element 20.

As illustrated in FIGS. 1 and 2, the secondary battery includes the exterior film 10, the battery element 20, a positive electrode lead 31, a negative electrode lead 32, and sealing films 41 and 42.

In the secondary battery described here, as described above, the exterior film 10 having flexibility or bendability is used as an exterior member for housing the battery element 20. Therefore, the secondary battery illustrated in FIG. 1 is a so-called laminate film type secondary battery.

As illustrated in FIG. 1, the exterior film 10 has a bag-shaped structure in which the battery element 20 is sealed in a housed state. This, the exterior film 10 houses a positive electrode 21, a negative electrode 22, and a separator 23.

Here, the exterior film 10 is a single film-shaped member, and is folded in a folding direction F. The exterior film 10 is provided with a recessed portion 10U for accommodating the battery element 20, and the recessed portion 10U is a so-called deep drawn portion.

The exterior film 10 is a three-layer laminate film in which a fusion layer, a metal layer, and a surface protective layer are laminated in this order from the inside, and in a state where the exterior film 10 is folded, outer peripheral edge portions of the fusion layers facing each other are fused to each other. The fusion layer contains a polymer compound such as polypropylene. The metal layer contains a metal material such as aluminum. The surface protective layer contains a polymer compound such as nylon.

However, the configuration (number of layers) of the exterior film 10 is not particularly limited, and may be one layer, two layers, or four or more layers.

The battery element 20 is housed in a bag-shaped exterior film 10. The battery element 20 is a so-called power generating element, and includes the positive electrode 21, the negative electrode 22, and the separator 23 as illustrated in FIGS. 1 and 2.

Here, since the battery element 20 is a so-called wound electrode body, the positive electrode 21 and the negative electrode 22 are wound around a winding axis P while facing each other with the separator 23 interposed therebetween. The winding axis P is an imaginary axis extending in the Y-axis direction.

The three-dimensional shape of the battery element 20 is not particularly limited. Here, since the battery element 20 has a flat three-dimensional shape, the shape of the sectional surface (sectional surface along the XZ plane) of the battery element 20 intersecting the winding axis P is a flat shape defined by a major axis J1 and a minor axis J2.

The major axis J1 is an imaginary axis extending in the X-axis direction, and has a length larger than the length of the minor axis J2. The minor axis J2 is an imaginary axis extending in the Z-axis direction intersecting the X-axis direction, and has a length smaller than the length of the major axis J1. Here, since the three-dimensional shape of the battery element 20 is a flat cylindrical shape, the shape of the sectional surface of the battery element 20 is a flat substantially elliptical shape.

As illustrated in FIG. 2, the positive electrode 21 includes a positive electrode active material layer 21B.

Here, the positive electrode 21 further includes a positive electrode current collector 21A that supports the positive electrode active material layer 21B. However, the positive electrode current collector 21A may be omitted.

The positive electrode current collector 21A is a member having conductivity and has a pair of surfaces on which the positive electrode active material layer 21B is provided. The positive electrode current collector 21A contains a conductive material such as a metal material, and specific examples of the conductive material include aluminum.

The positive electrode active material layer 21B contains any one kind or two or more kinds of positive electrode active materials occluding and releasing lithium. However, the positive electrode active material layer 21B may further contain any one kind or two or more kinds of other materials such as a positive electrode binder, a positive electrode conductive agent, and a dispersant. A method for forming the positive electrode active material layer 21B is not particularly limited, but is specifically a coating method or the like.

Here, the positive electrode active material layer 21B is provided on both surfaces of the positive electrode current collector 21A. However, the positive electrode active material layer 21B may be provided only on one surface of the positive electrode current collector 21A on the side where the positive electrode 21 faces the negative electrode 22.

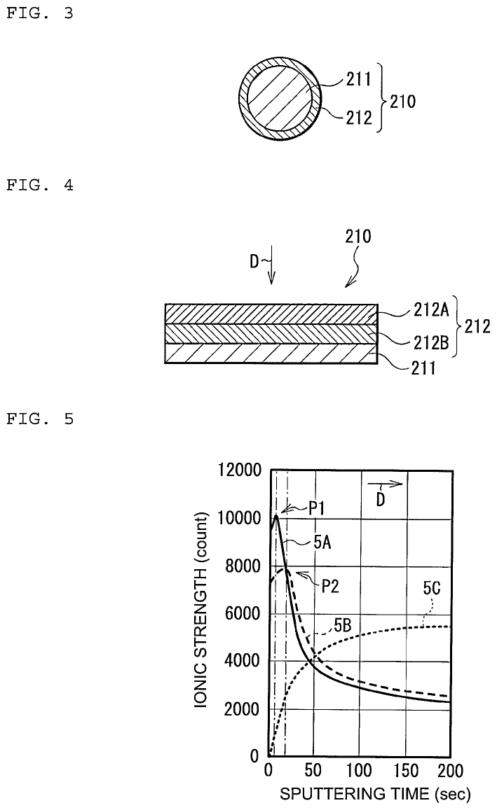

As illustrated in FIG. 3, the positive electrode active material layer 21B contains a plurality of particulate positive electrode active materials (hereinafter, referred to as “a plurality of positive electrode active material particles 210”), and the positive electrode active material particles 210 each include a central portion 211 and a covering portion 212. The detailed configuration of the positive electrode active material particle 210 will be described later (see FIG. 4).

The positive electrode binder is a material that binds particles such as the positive electrode active material particles 210 and contains any one kind or two or more kinds of materials such as synthetic rubber and a polymer compound. Specific examples of the synthetic rubber include styrene-butadiene rubber, fluorine rubber, and ethylene propylene diene. Specific examples of the polymer compound include polyvinylidene fluoride, polyimide, and carboxymethyl cellulose.

The positive electrode conductive agent is a material that improves the conductivity of the positive electrode active material layer 21B and contains any one kind or two or more kinds of conductive materials such as a carbon material, a metal material, and a conductive polymer compound. Specific examples of the carbon materials include graphite, carbon black, acetylene black, and Ketjen black.

The dispersant is a material that improves the dispersibility of particles of a positive electrode active material or the like in a manufacturing process of the secondary battery (a preparation process of a positive electrode mixture slurry) described later, and contains any one kind or two or more kinds of polymer compounds such as polyvinylpyrrolidone.

In the secondary battery, three kinds of physical property conditions are satisfied with respect to the physical properties of the positive electrode 21, and details of the three kinds of physical property conditions will be described later.

As illustrated in FIG. 2, the negative electrode 22 includes a negative electrode current collector 22A and a negative electrode active material layer 22B.

The negative electrode current collector 22A is a conductive member that supports the negative electrode active material layer 22B, and has a pair of surfaces on which the negative electrode active material layer 22B is provided. The negative electrode current collector 22A contains a conductive material such as a metal material, and specific examples of the conductive material include copper.

The negative electrode active material layer 22B contains any one kind or two or more kinds of negative electrode active materials occluding and releasing lithium. It should be understood that the negative electrode active material layer 22B may further contain any one kind or two or more kinds of other materials such as the negative electrode binder and the negative electrode conductive agent. The method for forming the negative electrode active material layer 22B is not particularly limited, but is specifically any one kind or two or more kinds of a coating method, a gas phase method, a liquid phase method, a thermal spraying method, a firing method (sintering method), and the like.

Here, the negative electrode active material layer 22B is provided on both surfaces of the negative electrode current collector 22A. However, the negative electrode active material layer 22B may be provided only on one surface of the negative electrode current collector 22A on the side where the negative electrode 22 faces the positive electrode 21.

The type of the negative electrode active material is not particularly limited, and specific examples thereof include a carbon material, a metal-based material, and the like. This is because a high energy density can be obtained.

Specific examples of the carbon materials include graphitizable carbon, non-graphitizable carbon, and graphite. The graphite may be natural graphite or artificial graphite.

The metal-based material is a material including any one kind or two or more kinds of metal elements and metalloid elements capable of forming an alloy with lithium as constituent elements, and specific examples of the metal elements and metalloid elements are silicon, tin, and the like. The metal-based material may be a simple substance, an alloy, a compound, a mixture of two or more kinds thereof, or a material including two or more phases thereof. However, since the simple substance described here may contain an arbitrary amount of impurities, the purity of the simple substance is not necessarily limited to 100%. Specific examples of the metal-based material include TiSi₂ and SiOₓ (0<x≤2 or 0.2<x<1.4).

The details of the negative electrode binder are the same as the details of the positive electrode binder, and the details of the negative electrode conductive agent are the same as the details of the positive electrode conductive agent.

As illustrated in FIG. 2, the separator 23 is an insulating porous film interposed between the positive electrode 21 and the negative electrode 22, and allows lithium to pass therethrough in an ionic state while preventing occurrence of a short circuit resulting from contact of the positive electrode 21 and the negative electrode 22. The separator 23 contains any one kind or two or more kinds of polymer compounds such as polyethylene.

An electrolytic solution which was a liquid electrolyte impregnates each of the positive electrode 21, the negative electrode 22, and the separator 23, and contains an electrolyte salt. Here, the electrolytic solution further contains a solvent for dissolving or dispersing the electrolyte salt.

The electrolyte salt contains any one kind or two or more kinds of fluorine-containing lithium salts, and the fluorine-containing lithium salt is a generic term for lithium salts containing fluorine as a constituent element as described above. Since the fluorine-containing lithium salt contains an anion together with a lithium ion which is a cation, fluorine is contained in the anion as a constituent element.

The reason why the electrolyte salt contains the fluorine-containing lithium salt is as described below. First, since a cation (lithium ion) of the fluorine-containing lithium salt functions as an electrode reactant, a high battery capacity can be obtained. Second, as described later, in a stabilization treatment of the assembled secondary battery, the reaction of forming hydrogen fluoride proceeds using fluorine contained as a constituent element in the fluorine-containing lithium salt, so that a precursor covering portion 212Z is converted into an upper covering portion 212A.

The type of the fluorine-containing lithium salt is not particularly limited as long as the anion contains fluorine as a constituent element. Specific examples of the fluorine-containing lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium difluoro(oxalato)borate (LiBF₂(C₂O₄)), lithium mono fluorophosphate (Li₂PFO₃), and lithium difluorophosphate (LiPF₂O₂).

Among them, the fluorine-containing lithium salt preferably contains one or both of lithium hexafluorophosphate and lithium bis(fluorosulfonyl)imide. This is because the precursor covering portion 212Z is easily converted into the upper covering portion 212A using the fluorine-containing lithium salt.

The content of the electrolyte salt in the electrolytic solution is not particularly limited, and is specifically 0.3 mol/kg to 3.0 mol/kg with respect to the solvent. This is because high ion conductivity can be obtained.

The electrolyte salt may further include any one kind or two or more kinds of other lithium salts. The other lithium salts are lithium salts containing no fluorine as a constituent element, and specific examples of the other lithium salts include lithium bis(oxalato)borate (LiB(C₂O₄)₂).

The solvent contains any one kind or two or more kinds of non-aqueous solvents (organic solvents), and the electrolytic solution containing the non-aqueous solvent is a so-called non-aqueous electrolytic solution.

The non-aqueous solvent is an ester, an ether, or the like, and more specifically, is a carbonic acid ester-based compound, a carboxylic acid ester-based compound, and a lactone-based compound, or the like. This is because a dissociative nature of the electrolyte salt is improved and mobility of the ions is improved.

The carbonic acid ester-based compound is a cyclic carbonic acid ester and a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic acid ester-based compound is a chain carboxylic acid ester or the like, and specific examples of the chain carboxylic acid ester include ethyl acetate, ethyl propionate, propyl propionate, and ethyl trimethylacetate. The lactone-based compound is a lactone or the like, and specific examples of the lactone include γ-butyrolactone and γ-valerolactone.

The ethers may be 1,2-dimethoxyethane, tetrahydrofuran, 1,3-dioxolane, 1,4-dioxane, or the like.

The electrolytic solution may further include any one kind or two or more kinds of additives.

Specifically, the additive is preferably a boron-fluorine-containing material. The boron-fluorine-containing material is a generic term for compounds containing boron and fluorine as constituent elements.

In a case where the electrolytic solution contains the boron-fluorine-containing material, as described later, in the stabilization treatment of the assembled secondary battery, the reaction of forming hydrogen fluoride easily proceeds using fluorine contained as a constituent element in the boron-fluorine-containing material, the precursor covering portion 212Z is easily converted into the upper covering portion 212A.

As long as the boron-fluorine-containing material contains boron and fluorine as constituent elements, the type of the boron-fluorine-containing material is not particularly limited. Specific examples of the boron-fluorine-containing material include lithium tetrafluoroborate and lithium difluoro(oxalato)borate. This is because the precursor covering portion 212Z is sufficiently converted into the upper covering portion 212A using the boron-fluorine-containing material.

The additives are an unsaturated cyclic carbonic acid ester, a fluorinated cyclic carbonic acid ester, a sulfonic acid ester, a phosphoric acid ester, an acid anhydride, a nitrile compound, and an isocyanate compound. This is because electrochemical stability of the electrolytic solution is improved.

Specific examples of the unsaturated cyclic carbonic acid ester include vinylene carbonate, vinyl ethylene carbonate, and methylene ethylene carbonate. Specific examples of the fluorinated cyclic carbonic acid ester include ethylene monofluorocarbonate and ethylene difluorocarbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

As illustrated in FIGS. 1 and 2, the positive electrode lead 31 is connected to the positive electrode current collector 21A of the positive electrode 21 and is led out to the outside of the exterior film 10. The positive electrode lead 31 contains a conductive material such as a metal material, and specific examples of the conductive material include aluminum. The shape of the positive electrode lead 31 is any of a thin plate shape, a mesh shape, and the like.

As illustrated in FIGS. 1 and 2, the negative electrode lead 32 is connected to the negative electrode current collector 22A of the negative electrode 22 and is led out to the outside of the exterior film 10. Here, the lead-out direction of the negative electrode lead 32 is the same as the lead-out direction of the positive electrode lead 31. The negative electrode lead 32 contains a conductive material such as a metal material, and specific examples of the conductive material include copper. The details of the shape of the negative electrode lead 32 are the same as the details of the shape of the positive electrode lead 31.

The sealing film 41 is inserted between the exterior film 10 and the positive electrode lead 31, and the sealing film 42 is inserted between the exterior film 10 and the negative electrode lead 32. However, one or both of the sealing films 41 and 42 may be omitted.

The sealing film 41 is a sealing member that prevents entry of outside air and foreign matter into the exterior film 10. The sealing film 41 contains a polymer compound such as polyolefin having the adhesive property to the positive electrode lead 31, and specific examples of the polymer compound include polypropylene.

The configuration of the sealing film 42 is the same as the configuration of the sealing film 41, except that the sealing film is a sealing member having the adhesive property to the negative electrode lead 32. That is, the sealing film 42 contains a polymer compound such as polyolefin having the adhesive property to the negative electrode lead 32.

FIG. 4 schematically illustrates the sectional configuration of the positive electrode active material particle 210 illustrated in FIG. 3. In FIG. 4, only a part of the positive electrode active material particle 210 in the vicinity of the surface is illustrated.

The positive electrode active material particle 210 includes the central portion 211 and the covering portion 212 as described above.

As illustrated in FIG. 3, the central portion 211 contains any one kind or two or more kinds of lithium composite oxides.

The lithium composite oxide is a substance occluding and releasing lithium ions. As described above, the lithium composite oxide is a generic term for oxides having a crystal structure of a layered rock salt type and containing lithium, nickel, and other elements as constituent elements. The other elements are any one kind or two or more kinds of elements other than lithium and nickel.

The type of other elements is not particularly limited as long as they are elements belonging to any of Groups 2 to 15 of the long periodic table. Specific examples of the other elements include cobalt, aluminum, manganese, zirconium, titanium, molybdenum, tantalum, chromium, niobium, iron, copper, zinc, vanadium, magnesium, tungsten, sulfur, strontium, boron, sodium, and fluorine. This is because a sufficient battery capacity can be obtained.

Specific examples of the lithium composite oxide include LiNi_{0.86}Co_{0.10}Mn_{0.04}O₂, LiNi_{0.88}Co_{0.10}Al_{0.02}O₂, and LiNi_{0.90}Co_{0.01}Mn_{0.01}Al_{0.01}O₂.

In the lithium composite oxide, a content of nickel is set to be sufficiently large. Specifically, when a sum of a content of the nickel in the lithium composite oxide and a content of the other elements in the lithium composite oxide is taken as 100 parts by mol, the content of the nickel is 80 parts by mol to 100 parts by mol.

As is apparent from the fact that the upper limit of the content of nickel is 100 parts by mol, the lithium composite oxide may contain other elements as constituent elements or may not contain other elements as constituent elements.

When the lithium composite oxide contains two or more other elements as constituent elements, the content of the other elements in the lithium composite oxide is the sum of the contents of the two or more other elements contained as constituent elements in the lithium composite oxide.

That is, when the content of nickel in the lithium composite oxide is designated as C1 (mol) and the content of the other elements in the lithium composite oxide is designated as C2 (mol), a content ratio C of nickel as calculated based on a calculation formula of C=[C1/(C1+C2)]×100 is 80 mol % to 100 mol %.

The reason why the content ratio is 80 mol % to 100 mol % is that as compared with a case where the content ratio is less than 80 mol %, the potential for occluding and releasing lithium is reduced, so that a high battery capacity can be obtained.

The procedure for specifying the content ratio is as described below. Hereinafter, a case where the positive electrode active material layer 21B contains a positive electrode active material (the plurality of positive electrode active material particles 210) and a positive electrode binder will be described.

First, the positive electrode 21 is recovered by disassembling the secondary battery, and then the positive electrode 21 is washed using a solvent for washing. The type of the solvent for washing is not particularly limited, and is specifically an organic solvent such as dimethyl carbonate. As a result, the electrolytic solution adhering to the positive electrode 21 is removed.

Subsequently, the positive electrode 21 is immersed in a solvent for dissolution removal. The type of the solvent for dissolution removal is not particularly limited, but is specifically N-methyl-2-pyrrolidone or the like capable of dissolving the positive electrode binder. As a result, the positive electrode binder contained in the positive electrode active material layer 21B is dissolved, so that the positive electrode current collector 21A is peeled from the positive electrode active material layer 21B.

Subsequently, the positive electrode current collector 21A is removed from the solvent for dissolution removal, and then the solvent for dissolution removal is filtered to recover the filtered product as a solid. As a result, the solvent for dissolution removal in which the positive electrode binder is dissolved is removed, so that the plurality of positive electrode active material particles 210 as a filtered product are obtained.

Subsequently, the positive electrode active material particles 210 are analyzed using any one kind or two or more kinds of analysis methods such as inductively coupled plasma (ICP) emission spectrometry. In this case, since the composition of the lithium composite oxide contained in the central portion 211 is analyzed, the content (mol) of a series of constituent elements contained in the lithium composite oxide is measured. Thus, each of the contents C1 and C2 is specified.

Finally, the content ratio C is calculated using the above-described calculation formula based on the contents C1 and C2.

More specifically, the lithium composite oxide contains any one kind or two or more kinds of compounds represented by Formula (1), and the compounds represented by Formula (1) contain other elements E as constituent elements.

LiₐNi_{b}E_{1-b}O₂ (1)
(E is any one kind or two or more kinds of Co, Al, Mn, Zr, Ti, Mo, Ta, Cr, Nb, Fe, Cu, Zn, V, Mg, W, S, Sr, B, Na, and F. a and b satisfy 0.8≤a≤1.05 and 0.8≤b≤1.0.)

The central portion 211 may further contain any one kind or two or more kinds of lithium-containing compounds occluding and releasing lithium. The lithium-containing compound is a generic term for compounds containing lithium as a constituent element, and the above-described lithium composite oxide is excluded from the lithium-containing compound described herein.

The lithium-containing compound is a compound containing lithium and one kind or two or more kinds of transition metal elements as constituent elements, and may further contain one kind or two or more kinds of additional elements as constituent elements. The type of the additional element is not particularly limited as long as it is an element other than lithium and the transition metal, and is specifically an element belonging to any of Groups 2 to 15 of the long periodic table. The type of the lithium-containing compound is not particularly limited, and specific examples thereof include an oxide, a phosphoric acid compound, a silicic acid compound, and a boric acid compound.

Specific examples of the oxide include LiCoO₂, LiCo_{0.98}Al_{0.01}Mg_{0.01}O₂, and LiMn₂O₄. Specific examples of the phosphoric acid compound include LiFePO₄, LiMnPO₄, and LiFe_{0.5}Mn_{0.5}PO₄.

As illustrated in FIG. 3, since the covering portion 212 is provided on the surface of the central portion 211, the covering portion 212 covers the surface of the central portion 211.

Here, the covering portion 212 covers the entire surface of the central portion 211. However, the covering portion 212 may cover only a part of the surface of the central portion 211. In this case, a plurality of covering portions 212 which are separated from each other may cover the surface of the central portion 211.

The covering portion 212 contains a material from which a first negative secondary ion derived from LiF₂⁻ and a second negative secondary ion derived from BO₂⁻ are detected in analysis in a depth direction D of the positive electrode active material layer 21B using time-of-flight secondary ion mass spectrometry (TOF-SIMS). The analysis in the depth direction D of the positive electrode active material layer 21B using TOF-SIMS described here is a so-called depth analysis.

Thus, the covering portion 212 contains lithium, fluorine, boron, and oxygen as constituent elements. The composition of the material for forming the covering portion 212 is not particularly limited as long as the first negative secondary ion and the second negative secondary ion can be detected in the depth analysis of the positive electrode active material layer 21B using TOF-SIMS described above.

The reason why the covering portion 212 is provided on the surface of the central portion 211 and the covering portion 212 contains lithium, fluorine, boron, and oxygen as constituent elements is that the heat generation of the positive electrode 21 is suppressed at the time of charging, and thus an excessive temperature rise of the positive electrode 21 is suppressed. In this case, as described later, since the three kinds of physical property conditions are satisfied with respect to the physical properties of the positive electrode 21, the central portion 211 contains the lithium composite oxide, and when the content ratio of the lithium composite oxide is 80 mol % or more, an excessive temperature rise of the positive electrode 21 is effectively suppressed.

As described above, since the central portion 211 contains the lithium composite oxide and the content ratio of the lithium composite oxide is 80 mol % or more, a high battery capacity can be obtained.

However, when the content ratio of the lithium composite oxide is 80 mol % or more, the crystal structure of the lithium composite oxide at the time of charging becomes unstable. In this case, when a minute internal short circuit or the like occurs inside the secondary battery, the temperature of the lithium composite oxide tends to increase excessively.

When the temperature of the lithium composite oxide is excessively increased, if the crystal structure of the lithium composite oxide is collapsed, oxygen and heat are released from the lithium composite oxide. The collapse of the crystal structure is likely to occur particularly in the vicinity of the surface of the lithium composite oxide in contact with the electrolytic solution.

From these, when the content ratio of the lithium composite oxide is 80 mol % or more, a high battery capacity can be obtained, but an exothermic reaction accelerates in the central portion 211, so that the temperature of the positive electrode 21 tends to increase excessively. This may cause problems such as ignition of the secondary battery.

On the other hand, when the covering portion 212 containing lithium, fluorine, boron, and oxygen as constituent elements is provided on the surface of the central portion 211 and the three kinds of physical property conditions are satisfied with respect to the physical properties of the positive electrode 21, the surface of the central portion 211 is electrochemically appropriately protected by the covering portion 212.

In this case, when the content ratio of the lithium composite oxide is 80 mol % or more, the crystal structure of the lithium composite oxide is less likely to collapse at the time of charging, so that oxygen and heat are less likely to be released from the lithium composite oxide. As a result, the temperature of the lithium composite oxide is less likely to increase excessively.

From these, since the content ratio of the lithium composite oxide is 80 mol % or more, not only a high battery capacity can be obtained, but also an exothermic reaction is less likely to proceed in the central portion 211, so that the temperature of the positive electrode 21 is less likely to increase excessively. Therefore, while the battery capacity is secured, an excessive temperature rise of the positive electrode 21 is suppressed at the time of overcharge, heating of the secondary battery, occurrence of internal short circuit, and the like. As a result, problems such as ignition of the secondary battery are less likely to occur.

Here, as described above, the configuration of the covering portion 212 is not particularly limited as long as the covering portion 212 contains lithium, fluorine, boron, and oxygen as constituent elements in order to enable detection of the first negative secondary ion and the second negative secondary ion in the depth analysis of the positive electrode active material layer 21B using TOF-SIMS, and the three kinds of physical property conditions are satisfied with respect to the physical properties of the positive electrode 21.

Specifically, as illustrated in FIG. 4, the covering portion 212 preferably includes the upper covering portion 212A and the lower covering portion 212B. That is, it is preferable that the covering portion 212 has a two-layer structure in which the upper covering portion 212A and the lower covering portion 212B are laminated in order from the side farther than the central portion 211. This is because the three kinds of physical property conditions are easily satisfied with respect to the physical properties of the positive electrode 21, and thus the temperature rise of the positive electrode 21 is sufficiently suppressed.

In FIG. 4, the configurations of the central portion 211, the upper covering portion 212A, and the lower covering portion 212B are simplified in order to make the configurations thereof easy to see. That is, in order to simplify the illustration, the central portion 211, the upper covering portion 212A, and the lower covering portion 212B are illustrated so as to have a simple three-layer structure.

However, a boundary between the upper covering portion 212A and the lower covering portion 212B may not be clear. In this case, since a part of the constituent material of the upper covering portion 212A may be diffused into the lower covering portion 212B, or a part of the constituent material of the lower covering portion 212B may be diffused into the upper covering portion 212A, the boundary between the upper covering portion 212A and the lower covering portion 212B may be unclear.

Of course, since a part of the constituent material of the upper covering portion 212A is diffused into the lower covering portion 212B, and a part of the constituent material of the lower covering portion 212B is diffused into the upper covering portion 212A, the constituent material of the upper covering portion 212A and the constituent material of the lower covering portion 212B may be diffused with each other.

In this case, one or two or more intermediate layers may be interposed between the upper covering portion 212A and the lower covering portion 212B due to the diffusion described above. The configuration of the intermediate layer is not particularly limited, but as an example, the intermediate layer includes both the constituent material of the upper covering portion 212A and the constituent material of the lower covering portion 212B.

The upper covering portion 212A is a first covering portion disposed on a side farther from the central portion 211 than the lower covering portion 212B.

The upper covering portion 212A preferably contains lithium and fluorine as constituent elements in order to enable detection of the first negative secondary ion in the depth analysis of the positive electrode active material layer 21B using TOF-SIMS described above. This is because the surface of the central portion 211 is easily electrochemically appropriately protected by the covering portion 212.

In particular, the upper covering portion 212A more preferably contains lithium fluoride (LiF). This is because the upper covering portion 212A is easily formed, and the surface of the central portion 211 is electrochemically sufficiently protected by the covering portion 212.

Here, as described later, the upper covering portion 212A is formed on the surface of the lower covering portion 212B by using the stabilization treatment (first charge and discharge treatment) of the assembled secondary battery in the manufacturing process of the secondary battery. Details of the method for forming the upper covering portion 212A will be described later.

In order to confirm that the upper covering portion 212A contains lithium and fluorine as constituent elements, the plurality of positive electrode active material particles 210 may be recovered from the secondary battery (positive electrode 21) using the same procedure as the procedure for specifying the content ratio described above, and then the positive electrode active material particles 210 (upper covering portion 212A) may be analyzed.

A method of analyzing the upper covering portion 212A is not particularly limited. Therefore, as the method of analyzing the upper covering portion 212A, any one kind or two or more kinds of arbitrary analysis methods can be used.

Specifically, the composition of the upper covering portion 212A may be analyzed by performing depth direction analysis of the positive electrode active material particles 210 using Auger electron spectroscopy (AES). The composition of the upper covering portion 212A may be analyzed by processing the positive electrode 21 using focused ion beam processing (FIB) or the like to obtain a thin piece including the upper covering portion 212A and then analyzing the thin piece using transmission electron microscope-electron energy loss spectroscopy (TEM-EELS).

The lower covering portion 212B is a second covering portion disposed on a side closer to the central portion 211 than the upper covering portion 212A.

The lower covering portion 212B preferably contains lithium, boron, and oxygen as constituent elements in order to enable detection of the second negative secondary ion in the depth analysis of the positive electrode active material layer 21B using TOF-SIMS described above. This is because the surface of the central portion 211 is easily electrochemically appropriately protected by the covering portion 212.

In particular, the lower covering portion 212B more preferably contains lithium metaborate (LiBO₂). This is because the lower covering portion 212B is easily formed, and the surface of the central portion 211 is electrochemically sufficiently protected by the covering portion 212.

The procedure for confirming that the lower covering portion 212B contains lithium, boron, and oxygen as constituent elements is the same as the procedure for confirming that the upper covering portion 212A contains lithium and fluorine as constituent elements, except that the lower covering portion 212B is analyzed instead of the upper covering portion 212A.

### <1-3. Physical Properties of Positive Electrode>

In the secondary battery, as described above, the three kinds of physical property conditions (first physical property condition, second physical property condition, and third physical property condition) are satisfied with respect to the physical properties of the positive electrode 21, more specifically, the physical properties of the positive electrode active material layer 21B.

Hereinafter, a case where the covering portion 212 includes the upper covering portion 212A (lithium fluoride) and the lower covering portion 212B (lithium metaborate) will be described.

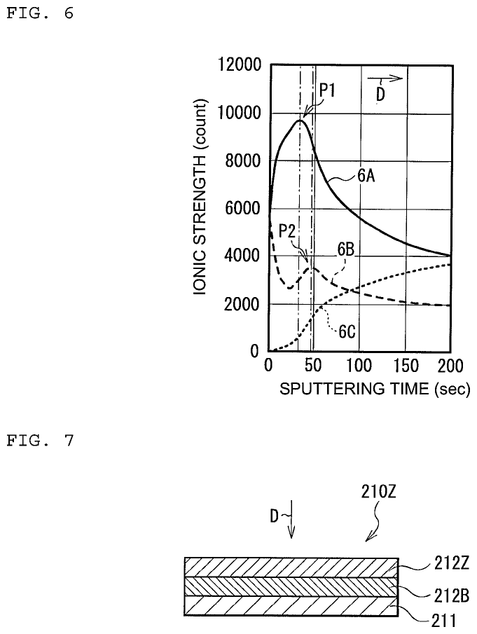

FIGS. 5 and 6 each show an example of the analysis result in the depth direction D of the positive electrode active material layer 21B using TOF-SIMS. The horizontal axis represents sputtering time (sec), and the vertical axis represents ionic strength (count).

The positive electrode active material layer 21B is subjected to depth analysis in the depth direction D using TOF-SIMS. As illustrated in FIGS. 2 and 4, the depth direction D is a direction corresponding to the thickness direction of the positive electrode active material layer 21B. More specifically, the depth direction D is a direction from the surface of the positive electrode active material layer 21B toward the inside of the positive electrode active material layer 21B, that is, a direction from the covering portion 212 toward the central portion 211.

In the depth analysis, normal ion analysis using primary ions and sputter etching for digging down the positive electrode active material layer 21B using sputter ions are alternately repeated in the depth direction D. As a result, the amount of various ions detected from the positive electrode active material layer 21B in the depth direction D is measured, and thus, as shown in FIGS. 5 and 6, an analysis result of depth analysis of the positive electrode active material layer 21B is acquired.

As described above, the horizontal axis represents the sputtering time during sputtering etching, and thus corresponds to the position in the depth direction D (so-called depth) inside the positive electrode active material layer 21B. As described above, since the vertical axis represents the ionic strength, the vertical axis corresponds to the detection amount of various ions in the depth direction D.

Here, as shown in FIGS. 3 and 4, the positive electrode active material particle 210 includes the central portion 211 and the covering portion 212, and the covering portion 212 includes the upper covering portion 212A and the lower covering portion 212B. The central portion 211 contains the lithium composite oxide and the content ratio of the lithium composite oxide is 80 mol % or more. As described above, the upper covering portion 212A contains lithium fluoride, and the lower covering portion 212B contains lithium metaborate.

Hereinafter, the three kinds of physical property conditions will be described by dividing a case where the electrolytic solution does not contain the boron-fluorine-containing material and a case where the electrolytic solution contains the boron-fluorine-containing material.

In a case the electrolytic solution does not contain the boron-fluorine-containing material, details of the first physical property condition, the second physical property condition, and the third physical property condition are as described below.

In the depth analysis of the positive electrode active material layer 21B using TOF-SIMS, the first negative secondary ion derived from LiF₂⁻ is detected.

As a result, as shown in FIG. 5, a first depth profile 5A representing the change in ionic strength of the first negative secondary ion in the depth direction D is acquired. In the first depth profile 5A, when the sputtering time increases, the detection amount of the first negative secondary ion increases and then decreases, so that the ionic strength of the first negative secondary ion increases and then decreases. As a result, the first depth profile 5A has a first peak P1.

In FIG. 5, a vertical line segment (one-dot chain line) passing through the first peak P1 represents the position of the first peak P1. Since the position of the first peak P1 is the sputtering time corresponding to the first peak P1, it is a depth representing the position in the depth direction D.

The reason why the ionic strength of the first negative secondary ion increases and then decreases in the depth direction D in the first depth profile 5A is as described below.

In the positive electrode active material layer 21B, not only the plurality of positive electrode active material particles 210 exist as described above, but also other materials such as a positive electrode binder and a positive electrode conductive agent exist. In the positive electrode active material particle 210, the lower covering portion 212B is disposed outside the central portion 211, and the upper covering portion 212A is disposed outside the lower covering portion 212B.

Since the upper covering portion 212A contains lithium fluoride, the upper covering portion 212A contains lithium and fluorine as constituent elements. On the other hand, other materials do not contain lithium and fluorine as constituent elements. Since the lower covering portion 212B contains lithium metaborate, the lower covering portion 212B contains lithium as a constituent element but does not contain fluorine as a constituent element. Since the central portion 211 contains a lithium composite oxide, the central portion 211 contains lithium as a constituent element but does not contain fluorine as a constituent element.

In this case, when the positive electrode active material layer 21B is subjected to depth analysis using TOF-SIMS, the analysis range moves toward a region where other materials exist, a region where the upper covering portion 212A exists, a region where the lower covering portion 212B exists, and a region where the central portion 211 exists, in this order. As a result, the first negative secondary ion is sufficiently detected in a region where lithium and fluorine are sufficiently present, whereas the first negative secondary ion is hardly detected in a region where lithium and fluorine are hardly present.

From these, the ionic strength of the first negative secondary ion decreases in the region where other materials exist, the ionic strength of the first negative secondary ion rapidly increases in the region where the upper covering portion 212A exists, the ionic strength of the first negative secondary ion rapidly decreases in the region where the lower covering portion 212B exists, and the ionic strength of the first negative secondary ion decreases in the region where the central portion 211 exists.

As a result, since the detection amount of the first negative secondary ion increases and then decreases in the depth direction D, the ionic strength of the first negative secondary ion increases and then decreases in the depth direction D.

In the depth analysis of the positive electrode active material layer 21B using TOF-SIMS, the second negative secondary ion derived from BO₂⁻ is detected.

As a result, as shown in FIG. 5, a second depth profile 5B representing the change in ionic strength of the second negative secondary ion in the depth direction D is acquired. In the second depth profile 5B, when the sputtering time increases, the detection amount of the second negative secondary ion increases and then decreases, so that the ionic strength of the second negative secondary ion increases and then decreases. As a result, the second depth profile 5B has a second peak P2.

In FIG. 5, a vertical line segment (one-dot chain line) passing through the second peak P2 represents the position of the second peak P2. Since the position of the second peak P2 is the sputtering time corresponding to the second peak P2, it is a depth representing the position in the depth direction D.

The reason why the ionic strength of the second negative secondary ion immediately increases and then decreases in the depth direction D in the second depth profile 5B is as described below.

Since the lower covering portion 212B contains lithium metaborate, the lower covering portion 212B contains boron as a constituent element. On the other hand, other materials do not contain boron as a constituent element. Since the upper covering portion 212A contains lithium fluoride, the upper covering portion 212A does not contain boron as a constituent element. Since the central portion 211 contains a lithium composite oxide, the central portion 211 does not contain boron as a constituent element.

In this case, when the positive electrode active material layer 21B is subjected to depth analysis using TOF-SIMS, the second negative secondary ion is sufficiently detected in a region where boron is sufficiently present, whereas the second negative secondary ion is hardly detected in a region where boron is hardly present.

From these, the ionic strength of the second negative secondary ion decreases in the region where each of the other materials and the upper covering portion 212A exists, the ionic strength of the second negative secondary ion rapidly increases in the region where the lower covering portion 212B exists, and the ionic strength of the second negative secondary ion rapidly decreases in the region where the central portion 211 exists.

As a result, since the detection amount of the second negative secondary ion increases and then decreases in the depth direction D, the ionic strength of the second negative secondary ion increases and then decreases in the depth direction D.

As described above, the first depth profile 5A has the first peak P1, and the second depth profile 5B has the second peak P2.

In this case, the second peak P2 is located on a deeper side than the first peak P1 in the depth direction D. That is, as shown in FIG. 5, when the depth increases toward the right side, the second peak P2 is located on the right side of the first peak P1.

The reason why the second peak P2 is located on a deeper side than the first peak P1 in the depth direction D is that, in the vicinity of the surface (covering portion 212) of the positive electrode active material particle 210, the upper covering portion 212A is located on a side farther from the central portion 211 than the lower covering portion 212B, and the lower covering portion 212B is located on a side closer to the central portion 211 than the upper covering portion 212A. In other words, when the covering portion 212 is provided on the surface of the central portion 211, the lower covering portion 212B is disposed outside the central portion 211, and the upper covering portion 212A is disposed outside the lower covering portion 212B.

The upper covering portion 212A contains lithium and fluorine as constituent elements as described above, and the lower covering portion 212B contains lithium, boron, and oxygen as constituent elements as described above.

As a result, as described above, the surface of the central portion 211 is electrochemically appropriately protected by the covering portion 212. Therefore, when the central portion 211 contains the lithium composite oxide and the content ratio of the lithium composite oxide is 80 mol % or more, the heat generation of the positive electrode 21 is suppressed at the time of overcharge, heating of the secondary battery, occurrence of internal short circuit, and the like, and thus the temperature rise of the positive electrode 21 is suppressed.

In the depth analysis of the positive electrode active material layer 21B using TOF-SIMS, as shown in FIG. 5, a third negative secondary ion derived from NiO₂⁻ is further detected, so that a third depth profile 5C representing the change in ionic strength of the third negative secondary ion in the depth direction D is acquired. In the third depth profile 5C, as the sputtering time increases, the ionic strength of the third negative secondary ion continuously increases. As a result, the third depth profile 5C has no peak.

The reason why the ionic strength of the third negative secondary ion continuously increases in the depth direction D in the third depth profile 5C is as described below.

Since the central portion 211 contains a lithium composite oxide, the central portion 211 contains nickel as a constituent element. On the other hand, each of the other materials, the upper covering portion 212A, and the lower covering portion 212B does not contain nickel as a constituent element.

In this case, when the positive electrode active material layer 21B is subjected to depth analysis using TOF-SIMS, the third negative secondary ion is sufficiently detected in a region where nickel is sufficiently present, whereas the third negative secondary ion is hardly detected in a region where nickel is hardly present.

From these, the ionic strength of the third negative secondary ion decreases in the region where each of the other materials, the upper covering portion 212A, and the lower covering portion 212B exists, and the ionic strength of the third negative secondary ion increases in the region where the central portion 211 exists.

As a result, since the detection amount of the third negative secondary ion continuously increases in the depth direction D, the ionic strength of the third negative secondary ion continuously increases in the depth direction D.

For comparison, positive electrode active material particles having the same configuration as the configuration of the positive electrode active material particles 210, except that the covering portion 212 does not include the lower covering portion 212B, are considered. Since the positive electrode active material particle includes the central portion 211 and the covering portion 212 (upper covering portion 212A), the covering portion 212 does not include the lower covering portion 212B.

In this case, when the positive electrode active material layer 21B is subjected to depth analysis using TOF-SIMS, since the second negative secondary ion is hardly detected, in the depth profile representing the change in ionic strength of the second negative secondary ion in the depth direction D, the ionic strength of the second negative secondary ion hardly changes when the sputtering time increases. As a result, the depth profile has no peak unlike the second depth profile 5B.

In a case where the electrolytic solution contains the boron-fluorine-containing material, details of the first physical property condition, the second physical property condition, and the third physical property condition are as described below.

In the depth analysis of the positive electrode active material layer 21B using TOF-SIMS, the first negative secondary ion derived from LiF₂⁻ is detected.

As a result, as shown in FIG. 6, a first depth profile 6A representing the change in ionic strength of the first negative secondary ion in the depth direction D is acquired. Since the first depth profile 6A corresponds to the first depth profile 5A shown in FIG. 5, the details of the first depth profile 6A are similar to the details of the first depth profile 5A. Therefore, in the first depth profile 6A, as the sputtering time increases, the ionic strength of the first negative secondary ion increases and then decreases for the reason described above, and thus the first depth profile 6A has the first peak P1.

In the depth analysis of the positive electrode active material layer 21B using TOF-SIMS, the second negative secondary ion derived from BO₂⁻ is detected.

As a result, as shown in FIG. 6, a second depth profile 6B representing the change in ionic strength of the second negative secondary ion in the depth direction D is acquired. Since the second depth profile 6B corresponds to the second depth profile 5B shown in FIG. 5, the details of the second depth profile 6B are similar to the details of the second depth profile 5B. Therefore, in the second depth profile 6B, as the sputtering time increases, the ionic strength of the second negative secondary ion increases and then decreases for the reason described above, and thus the second depth profile 6B has the second peak P2.

However, in a case where the electrolytic solution contains the boron-fluorine-containing material, the positive electrode 21 is impregnated with the electrolytic solution, whereby boron contained as a constituent element in the boron-fluorine-containing material adheres to the surfaces of the positive electrode active material particles 210.

In this case, the ionic strength of the second negative secondary ion locally increases in the vicinity of the surface of the positive electrode active material particle 210. As a result, in the second depth profile 6B, the ionic strength of the second negative secondary ion immediately decreases in the depth direction D, increases in the depth direction D, and then decreases. The reason why the ionic strength of the second negative secondary ion increases and then decreases in the depth direction D in the second depth profile 6B is as described above.

As described above, the first depth profile 6A has the first peak P1, and the second depth profile 6B has the second peak P2. In this case, as described above, the second peak P2 is located on a deeper side than the first peak P1 in the depth direction D. The reason why the second peak P2 is located on a deeper side than the first peak P1 in the depth direction D is as described above.

As a result, as described above, the surface of the central portion 211 is electrochemically appropriately protected by the covering portion 212. Therefore, when the central portion 211 contains the lithium composite oxide and the content ratio of the lithium composite oxide is 80 mol % or more, the heat generation of the positive electrode 21 is suppressed at the time of overcharge, heating of the secondary battery, occurrence of internal short circuit, and the like, and thus the temperature rise of the positive electrode 21 is suppressed.

In the depth analysis of the positive electrode active material layer 21B using TOF-SIMS, as shown in FIG. 6, a third negative secondary ion derived from NiO₂⁻ is further detected, so that a third depth profile 6C representing the change in ionic strength of the third negative secondary ion in the depth direction D is acquired. Since the third depth profile 6C corresponds to the third depth profile 5C shown in FIG. 5, the details of the third depth profile 6C are substantially similar to the details of the third depth profile 5C. Therefore, in the third depth profile 6C, as the sputtering time increases, the ionic strength of the third negative secondary ion continuously increases for the reason described above, and thus the third depth profile 6C has no peak.

As an analyzer for TOF-SIMS, TOF-SIMS analyzer TOF-SIMS V manufactured by IONTOF GmbH can be used. The analysis conditions are as follows: primary ion=Bi³⁺, acceleration voltage of ion gun=25 keV, analysis mode=depth direction analysis by High Current Bunched, current of irradiated ions (measurement with pulse beam)=0.2 pA, pulse frequency=10 kHz, mass range=1 amu to 800 amu, scanning range=200 μm×200 μm, sputtering ion=Ar+, acceleration voltage of sputtering ion gun=1 kV, emission current=200 mA, and sputtering area=500 μm×500 μm.

A procedure for confirming whether or not the three kinds of physical property conditions are satisfied by subjecting the positive electrode active material layer 21B to depth analysis using TOF-SIMS is as described below.

First, the secondary battery is discharged in the atmosphere until the voltage reaches 2.0 V. The current at the time of discharging is not particularly limited, and thus can be arbitrarily set.

Subsequently, the secondary battery is disassembled inside a glove box to recover the positive electrode 21, and then the positive electrode 21 is washed using a solvent for washing. As a result, the electrolytic solution impregnated in the positive electrode 21 is removed. The type of the solvent for washing is not particularly limited, and is specifically any one kind or two or more kinds of organic solvents such as dimethyl carbonate.

Subsequently, the washed positive electrode 21 is attached to a sample holder using an adhesive tape. The type of the adhesive tape is not particularly limited, and is specifically a carbon tape or the like. Subsequently, the positive electrode active material layer 21B is subjected to depth analysis using TOF-SIMS to acquire the analysis result shown in FIG. 5 or 6.

Finally, based on the analysis result shown in FIG. 5 or 6, it is confirmed whether or not the three kinds of physical property conditions are satisfied.

Specifically, since the first negative secondary ion is detected, when the first depth profile 5A having the first peak P1 is acquired, the first physical property condition is satisfied. On the other hand, when the first negative secondary ion is not detected, or when the first negative secondary ion is detected but the first depth profile 5A having the first peak P1 is not acquired, the first physical property condition is not satisfied.

Since the second negative secondary ion is detected, when the second depth profile 5B having the second peak P2 is acquired, the second physical property condition is satisfied. On the other hand, when the second negative secondary ion is not detected, or when the second negative secondary ion is detected but the second depth profile 5B having the second peak P2 is not acquired, the second physical property condition is not satisfied.

When the second peak P2 is located on a deeper side than the first peak P1 in the depth direction D, the third physical property condition is satisfied. On the other hand, when the second peak P2 is not located on a deeper side than the first peak P1 in the depth direction D, the third physical property condition is not satisfied.

The reason why TOF-SIMS (depth analysis) is used as an analysis method for examining the physical properties of the positive electrode 21 is as described below.

First, since the thickness of the covering portion 212 (the upper covering portion 212A and the lower covering portion 212B) is about several nm, it is assumed that the covering portion is significantly thin. In this case, in order to analyze the positive electrode active material layer 21B in the depth direction D, it is effective to adopt TOF-SIMS (depth analysis) having remarkably high depth resolution.

Second, when a plurality of kinds of compounds are present inside the positive electrode active material layer 21B, it is more effective to use TOF-SIMS capable of individually examining the compositions of the plurality of kinds of compounds than to use an analysis method capable of examining the average composition of the positive electrode active material layer 21B.

Specifically, in general, analysis methods such as X-ray photoelectron spectroscopy (XPS) and electron energy loss spectroscopy (TEM-EELS) are used in the case of examining the composition and the like of the coating film.

However, in XPS, since the spectrum derived from boron and the spectrum derived from phosphorus overlap each other, it is difficult to examine the chemical bonding state of boron, and also difficult to examine the presence or absence of boron.

In TEM-EELS (particle section analysis), when a coating film is subjected to line analysis in the depth direction D, an average composition including lithium, boron, and oxygen is analyzed in a state where not only lithium metaborate but also other compounds are contained, and thus it is difficult to analyze only the lithium metaborate.

On the other hand, in TOF-SIMS, since the average composition including lithium, boron, and oxygen is analyzed only for lithium metaborate, it is possible to analyze only the lithium metaborate.

Third, in the surface analysis using TOF-SIMS, it is possible to analyze various ions existing on the surface of the coating film, but it is difficult to analyze various ions existing inside the coating film.

On the other hand, in the depth analysis using TOF-SIMS, not only various ions existing on the surface of the coating film can be analyzed, but also various ions existing inside the coating film can be analyzed. As a result, it is possible to analyze various ions existing inside the positive electrode active material layer 21B, and more specifically, it is possible to analyze various ions existing inside covering portion 212 (the upper covering portion 212A and the lower covering portion 212B) provided on the surface of the central portion 211.

The secondary battery operates as follows in the battery element 20.

During charging, lithium is released from the positive electrode 21, and the lithium is occluded in the negative electrode 22 with the electrolytic solution interposed therebetween. On the other hand, during discharging, lithium is released from the negative electrode 22, and the lithium is occluded in the positive electrode 21 with the electrolytic solution interposed therebetween. At the time of discharge and the time of charge, lithium is occluded and released in an ionic state.

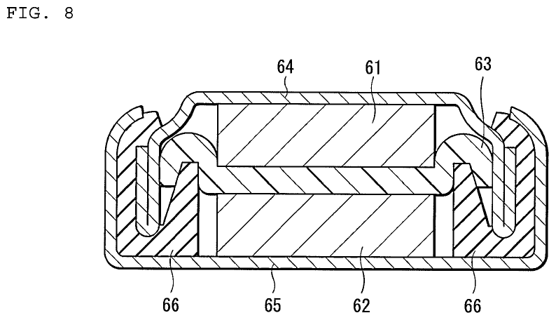

FIG. 7 illustrates a sectional configuration corresponding to FIG. 4 in order to explain a method for manufacturing a secondary battery.

In the case of manufacturing a secondary battery, after the positive electrode 21 and the negative electrode 22 are produced using an exemplary procedure described below and an electrolytic solution is prepared, a secondary battery is assembled using the positive electrode 21, the negative electrode 22, and the electrolytic solution, and the stabilization treatment of the assembled secondary battery is performed.

Hereinafter, a case where the upper covering portion 212A contains lithium fluoride and the lower covering portion 212B contains lithium metaborate will be described.

First, a plurality of central portions 211 each containing a lithium composite oxide are prepared. The content ratio of the lithium composite oxide is 80 mol % or more as described above.

Subsequently, a powdery boron-oxygen-containing material is supplied to the surface of each of the plurality of central portions 211. The boron-oxygen-containing material is a material containing boron and oxygen as constituent elements, and is a material for forming the lower covering portion 212B. Here, as described above, in order to form the lower covering portion 212B containing lithium metaborate, powdery lithium metaborate containing lithium as a constituent element together with boron and oxygen is used as a boron-containing material.

As a result, since the powdery boron-oxygen-containing material is fixed to the surface of each of the plurality of central portions 211, the surface of each of the plurality of central portions 211 is dry-coated with the powdery boron-oxygen-containing material. Therefore, as illustrated in FIG. 7, the lower covering portion 212B containing a boron-oxygen-containing material is formed on the surface of each of the plurality of central portions 211.

In this case, the surface of each of the plurality of central portions 211 may be dry-coated with the boron-oxygen-containing material, and then the plurality of central portions 211 may be fired. This is because the boron-oxygen-containing material easily diffuses uniformly on the surface of the central portion 211, and the fixability of the boron-oxygen-containing material to the surface of the central portion 211 is improved. The firing temperature is not particularly limited, but is specifically 300° C. to 500° C.

Subsequently, a powdery carbon-oxygen-containing material is supplied to the surface of each of the plurality of central portions 211 on which the lower covering portion 212B is formed. The carbon-oxygen-containing material is a material containing carbon and oxygen as constituent elements, and is a material for forming the precursor covering portion 212Z described later which is formed before the upper covering portion 212A is formed. Here, as described above, in order to form the upper covering portion 212A containing lithium fluoride, powdery lithium carbonate (Li₂CO₃) containing lithium as a constituent element together with carbon and oxygen is used as a carbon-oxygen-containing material.

As a result, since the powdery carbon-oxygen-containing material is fixed to the surface of the lower covering portion 212B, the surface of the lower covering portion 212B is dry-coated with the powdery carbon-oxygen-containing material. Therefore, as illustrated in FIG. 7, the precursor covering portion 212Z containing a carbon-oxygen-containing material is formed on the surface of the lower covering portion 212B. The precursor covering portion 212Z is a preparation layer used for forming the upper covering portion 212A using the stabilization treatment of the assembled secondary battery described later.

In this case, the surface of the lower covering portion 212B may be dry-coated with the carbon-oxygen-containing material, and then the lower covering portion 212B may be fired. This is because the carbon-oxygen-containing material easily diffuses uniformly on the surface of the lower covering portion 212B, and the fixability of the carbon-oxygen-containing material to the surface of the lower covering portion 212B is improved. The firing temperature is not particularly limited, but is specifically about 300° C.

As described above, the firing temperature of the lower covering portion 212B is preferably lower than the firing temperature of the plurality of central portions 211. This is to suppress unintentional excessive diffusion of the constituent material of the lower covering portion 212B and the constituent material of the upper covering portion 212A into each other when the upper covering portion 212A is formed on the lower covering portion 212B in a process described later.

From these, as illustrated in FIG. 7, a plurality of precursor particles 210Z each including the central portion 211, the lower covering portion 212B, and the precursor covering portion 212Z are formed.

Subsequently, the plurality of precursor particles 210Z, a positive electrode binder, and a positive electrode conductive agent are mixed together to obtain a positive electrode mixture. Subsequently, the positive electrode mixture is put into a solvent to prepare a positive electrode mixture slurry in the form of paste. The solvent may be an aqueous solvent or an organic solvent.

Subsequently, the positive electrode mixture slurry is applied to both sides of the positive electrode current collector 21A to form a precursor layer (not illustrated). Since the precursor layer includes the precursor covering portion 212Z instead of the upper covering portion 212A, the precursor layer has the same configuration as the configuration of the positive electrode active material layer 21B, except that the covering portion 212 is not provided on the surfaces of the plurality of central portions 211 yet. Thereafter, the precursor layer may be compression-molded using a compression device such as a roll press machine. In this case, the precursor layer may be heated or may be repeatedly subjected to compression molding more than once.

Subsequently, the positive electrode current collector 21A on which the precursor layer is formed is stored in a humidified environment. As the humidified environment, an environmental tester capable of adjusting humidity or the like is used. The storage conditions such as humidity and storage time are not particularly limited, and thus can be arbitrarily set.

As a result, moisture (H₂O) adheres to the surface of the precursor layer. The adhesion amount of moisture can be arbitrarily set according to the storage conditions described above.

Moisture is attached to the surface of the precursor layer in order to convert the precursor covering portion 212Z into the upper covering portion 212A using a reaction between the moisture and the precursor covering portion 212Z (carbon-oxygen-containing material) as described later.

Finally, as described later, after the secondary battery is assembled, a stabilization treatment is performed using the assembled secondary battery.

In the stabilization treatment, moisture adhering to the surface of the precursor layer and the carbon-oxygen-containing material react with each other, so that the precursor covering portion 212Z is converted into the upper covering portion 212A. As a result, since the covering portion 212 including the upper covering portion 212A and the lower covering portion 212B is formed on the surface of each of the plurality of central portions 211, the plurality of precursor particles 210Z are converted into the plurality of positive electrode active material particles 210. Therefore, since the positive electrode active material layer 21B containing the plurality of positive electrode active material particles 210 is formed, the positive electrode 21 is produced.

Details of the reaction in which the precursor covering portion 212Z is converted into the upper covering portion 212A will be described later.

In the case of producing the positive electrode 21, the amount of each of the upper covering portion 212A and the lower covering portion 212B formed can be adjusted.

Specifically, the amount of the upper covering portion 212A formed changes according to the dry coating amount of the carbon-oxygen-containing material. As a result, the thickness of the upper covering portion 212A can be adjusted, and the content of the upper covering portion 212A in the positive electrode active material particle 210 can be adjusted.

Since the amount of moisture adhering to the surface of the precursor layer changes according to the storage condition in the humidified environment, the amount of the upper covering portion 212A formed changes. As a result, the thickness of the upper covering portion 212A can be adjusted, and the content of the upper covering portion 212A in the positive electrode active material particle 210 can be adjusted.

The amount of the lower covering portion 212B formed changes according to the dry coating amount of the boron-oxygen content. As a result, the thickness of the lower covering portion 212B can be adjusted, and the content of the lower covering portion 212B in the positive electrode active material particle 210 can be adjusted.

First, a negative electrode active material, a negative electrode binder, and a negative electrode conductive agent are mixed together to obtain a negative electrode mixture. Subsequently, the negative electrode mixture is put into a solvent to prepare a negative electrode mixture slurry in the form of paste. The details of the solvent are as described above. Finally, the negative electrode mixture slurry is applied to both sides of the negative electrode current collector 22A to form the negative electrode active material layer 22B. Thereafter, the negative electrode active material layer 22B may be compression-molded using a compression device such as a roll press machine. In this case, the negative electrode active material layer 22B may be heated, or compression molding may be repeated plural times. Thereby, the negative electrode 22 is produced.

The electrolyte salt is put into the solvent. As a result, the electrolyte salt is dispersed or dissolved in the solvent, thereby preparing an electrolytic solution. In this case, a boron-fluorine-containing material may be added to the electrolytic solution as necessary.

First, the positive electrode lead 31 is connected to the positive electrode current collector 21A of the positive electrode 21 by a joining method such as a welding method, and the negative electrode lead 32 is connected to the negative electrode current collector 22A of the negative electrode 22 by a joining method such as a welding method.

Subsequently, the positive electrode current collector 21A on which the precursor layer is formed and the negative electrode 22 are laminated on each other with the separator 23 interposed therebetween, thereby forming a laminate (not illustrated). Subsequently, the laminate is wound to produce a wound body (not illustrated), and then the wound body is pressed using a compression device such as a press machine to form the wound body into a flat shape. The wound body after molding has the same configuration as the configuration of the battery element 20, except that the wound body includes the precursor layer instead of the positive electrode active material layer 21B and is not impregnated with the electrolytic solution.

Subsequently, after the wound body is accommodated in the recessed portion 10U, the exterior film 10 (fusion layer/metal layer/surface protective layer) is folded to cause the exterior films 10 to face each other. Subsequently, outer peripheral edge portions of two sides of the fusion layers facing each other are adhered to each other using a bonding method such as a heat fusion method, whereby the wound body is housed in the bag-shaped exterior film 10.

Finally, after the electrolytic solution is injected into the bag-shaped exterior film 10, the outer peripheral edge portions of the remaining one side of the fusion layers facing each other are bonded to each other using a bonding method such as a heat fusion method. In this case, the sealing film 41 is inserted between the exterior film 10 and the positive electrode lead 31, and the sealing film 42 is inserted between the exterior film 10 and the negative electrode lead 32.

As a result, the wound body is impregnated with the electrolytic solution, and the wound body is enclosed inside the bag-shaped exterior film 10, so that the secondary battery is assembled.

Here, a procedure of the stabilization treatment will be described, and then a reaction in which the precursor covering portion 212Z is converted into the upper covering portion 212A will be described.

First, the assembled secondary battery is charged in a normal-temperature, normal-humidity environment. The charge conditions can be arbitrarily set. The temperature of the environment is not particularly limited, but specifically 10° C. to 35° C., and the humidity of the environment is not particularly limited, but specifically 10% to 60%.

Subsequently, the assembled secondary battery in a charged state is stored in a high-temperature environment. The environmental temperature is not particularly limited, but specifically 50° C. to 90° C., and the storage time is not particularly limited, but specifically 3 hours to 48 hours.

Finally, the assembled secondary battery in a charged state is discharged in a normal-temperature, normal-humidity environment. The discharge conditions can be arbitrarily set. The details of the temperature and humidity of the environment are as described above.

As a result, since the precursor covering portion 212Z is converted into the upper covering portion 212A as described above, the plurality of precursor particles 210Z are converted into the plurality of positive electrode active material particles 210. in this case, since the covering portion 212 including the upper covering portion 212A and the lower covering portion 212B is formed on the surface of each of the plurality of central portions 211, the plurality of positive electrode active material particles 210 are formed. Therefore, since the positive electrode active material layer 21B containing the plurality of positive electrode active material particles 210 is formed, the positive electrode 21 is produced.

Since a coating film is formed on the surface of the positive electrode 21, the positive electrode 21 is electrochemically stabilized, and since a coating film is formed on the surface of the negative electrode 22, the negative electrode 22 is electrochemically stabilized.

From these, the battery element 20 including the positive electrode 21, the negative electrode 22, and the electrolytic solution is produced, and the battery element 20 is enclosed in the bag-shaped exterior film 10, so that the secondary battery is completed.

In the stabilization treatment, the precursor covering portion 212Z is converted into the upper covering portion 212A using a reaction described below.

Hereinafter, a case where the fluorine-containing lithium salt contained in the electrolytic solution is lithium hexafluorophosphate will be described. A case where the electrolytic solution contains a boron-fluorine-containing material and the boron-fluorine-containing material is lithium tetrafluoroborate will be described.

As described above, before the stabilization treatment is performed, the precursor covering portion 212Z containing the carbon-oxygen-containing material (lithium carbonate) is formed on the surface of the lower covering portion 212B.

In the stabilization treatment, when the assembled secondary battery is stored in a high-temperature environment, moisture present in the vicinity of the surface of the precursor covering portion 212Z and the fluorine-containing lithium salt contained in the electrolytic solution react with each other, so that a reaction represented by Formula (11) proceeds. This reaction is likely to proceed in the vicinity of the surface of the precursor covering portion 212Z where a large amount of moisture exists.

H₂O+LiPF₆→LiF+2HF+POF₃ (11)

As a result, hydrogen fluoride (HF) is formed by using the reaction between moisture and the fluorine-containing lithium salt, so that the concentration of hydrogen fluoride increases in the electrolytic solution. That is, the fluorine-containing lithium salt becomes a generation source of hydrogen fluoride.

When the concentration of hydrogen fluoride in the electrolytic solution increases, the carbon-oxygen-containing material (Li₂CO₃) contained in the precursor covering portion 212Z and hydrogen fluoride react with each other, so that a reaction represented by Formula (12) proceeds.

Li₂CO₃+2HF→2LiF+CO₂+H₂O (12)

As a result, lithium fluoride (LiF) is formed using the reaction between the carbon-oxygen-containing material and hydrogen fluoride, so that the carbon-oxygen-containing material is changed to lithium fluoride. Therefore, since the upper covering portion 212A containing lithium fluoride is formed, the precursor covering portion 212Z is converted into the upper covering portion 212A.

In this case, when the electrolytic solution contains the boron-fluorine-containing material, a reaction represented by Formula (13) proceeds. That is, the boron-fluorine-containing material becomes a generation source of hydrogen fluoride similarly to the fluorine-containing lithium salt.

2LiBF₄+3H₂O→2LiF+B₂O₃+6HF (13)

As a result, hydrogen fluoride is formed using the reaction between the boron-fluorine-containing material and moisture, so that the reaction represented by Formula (12) is likely to proceed. Therefore, the precursor covering portion 212Z is easily converted into the upper covering portion 212A.

According to the secondary battery, the positive electrode active material layer 21B of the positive electrode 21 contains the plurality of positive electrode active material particles 210, the positive electrode active material particles 210 each include the central portion 211 and the covering portion 212, the central portion 211 contains a lithium composite oxide, the lithium composite oxide has a crystal structure of a layered rock salt type and contains lithium, nickel, and other elements as constituent elements, the content ratio of the lithium composite oxide is 80 mol % or more, the covering portion 212 contains lithium, fluorine, boron, and oxygen as constituent elements, and the electrolyte salt of the electrolytic solution contains a fluorine-containing lithium salt.

The three kinds of physical property conditions are easily satisfied with respect to the physical properties of the positive electrode 21. Specifically, in the depth analysis of the positive electrode active material layer 21B using TOF-SIMS, a first negative secondary ion derived from LiF₂⁻ and a second negative secondary ion derived from BO₂⁻ are detected, and a second peak P2 in a change in ionic strength of the second negative secondary ion is located on a deeper side in the depth direction D than a first peak P1 in a change in ionic strength of the first negative secondary ion.

In this case, since the central portion 211 contains the lithium composite oxide and the content ratio of the lithium composite oxide is 80 mol % or more, the potential occluding and releasing lithium decreases as described above. As a result, a high battery capacity can be obtained.

Moreover, since the three kinds of physical property conditions are easily satisfied with respect to the physical properties of the positive electrode 21, as described above, the surface of the central portion 211 is electrochemically appropriately protected by the covering portion 212. As a result, when the content ratio of the lithium composite oxide is 80 mol % or more, the heat generation of the positive electrode 21 is suppressed at the time of overcharge, heating of the secondary battery, occurrence of internal short circuit, and the like. As a result, when the state of the secondary battery becomes an unsafe state, the temperature rise of the positive electrode 21 is suppressed, so that problems such as ignition of the secondary battery are less likely to occur.

From these, while the battery capacity is secured based on the central portion 211, an excessive temperature rise of the positive electrode 21 is suppressed based on the covering portion 212 at the time of overcharge, heating of the secondary battery, occurrence of internal short circuit, and the like. Therefore, excellent safety can be obtained while battery characteristics are secured.

In particular, when the covering portion 212 includes the upper covering portion 212A and the lower covering portion 212B in order from the side farther than the central portion 211, the upper covering portion 212A contains lithium and fluorine as constituent elements, and the lower covering portion 212B contains lithium, boron, and oxygen as constituent elements, the three kinds of physical property conditions are easily satisfied with respect to the physical properties of the positive electrode 21. Therefore, since the surface of the central portion 211 is easily electrochemically protected by the covering portion 212, a higher effect can be obtained.

In this case, when the upper covering portion 212A contains lithium fluoride and the lower covering portion 212B contains lithium metaborate, the surface of the central portion 211 is sufficiently electrochemically protected by the covering portion 212, so that a higher effect can be obtained.

When the lithium composite oxide contains, as other elements, any one kind or two or more kinds of cobalt, aluminum, manganese, zirconium, titanium, molybdenum, tantalum, chromium, niobium, iron, copper, zinc, vanadium, magnesium, tungsten, sulfur, strontium, boron, sodium, and fluorine, a sufficient battery capacity can be obtained, so that a higher effect can be obtained.

When the fluorine-containing lithium salt contains one or both of lithium hexafluorophosphate and lithium bis(fluorosulfonyl)imide, the precursor covering portion 212Z is easily converted into the upper covering portion 212A using the fluorine-containing lithium salt, so that a higher effect can be obtained.

When the electrolytic solution further contains the boron-fluorine-containing material, the precursor covering portion 212Z is easily converted into the upper covering portion 212A using the boron-fluorine-containing material, so that a higher effect can be obtained.

In this case, when the boron-fluorine-containing material contains one or both of lithium tetrafluoroborate and lithium difluoro(oxalato)borate, the precursor covering portion 212Z is sufficiently converted into the upper covering portion 212A using the boron-fluorine-containing material, so that a higher effect can be obtained.

When the secondary battery is a lithium ion secondary battery, a sufficient battery capacity can be stably obtained using occlusion and release of lithium, so that a higher effect can be obtained.

Next, modification examples of the above-described secondary batteries will be described according to an embodiment. The configuration of the secondary battery can be appropriately changed as described below. However, a series of modification examples described below may be combined with each other.

The separator 23 which is a porous film was used. However, although not specifically illustrated in the drawings, a laminated type separator may be used instead of the separator 23 which is a porous film.

Specifically, the laminated type separator includes a porous film and a polymer compound layer. The porous film has a pair of surfaces, and the polymer compound layer is provided on one surface or both surfaces of the porous film. This is because the adhesive property of the separator to each of the positive electrode 21 and the negative electrode 22 is improved, so that positional displacement of the battery element 20 is suppressed. As a result, since the winding deviation of each of the positive electrode 21, the negative electrode 22, and the separator is suppressed, the swelling of the secondary battery is suppressed when the decomposition reaction of the electrolytic solution occurs. The polymer compound layer contains a polymer compound such as a polyvinylidene fluoride. This is because polyvinylidene fluoride has excellent physical strength and is electrochemically stable.

One or both of the porous film and the polymer compound layer may contain any one kind or two or more kinds of a plurality of insulating particles. This is because the plurality of insulating particles dissipate heat at the time of heat generation of the secondary battery, thereby improving the safety (heat resistance) of the secondary battery. The plurality of insulating particles contain any one kind or two or more kinds of insulating materials such as an inorganic material and a resin material. Specific examples of the inorganic material include aluminum oxide, aluminum nitride, boehmite, silicon oxide, titanium oxide, magnesium oxide, and zirconium oxide. Specific examples of the resin material include an acrylic resin and a styrene resin.

In the case of producing a laminated type separator, a precursor solution containing a polymer compound and an organic solvent is prepared, and then the precursor solution is applied to one surface or both surfaces of the porous film. In this case, a plurality of insulating particles may be contained in the precursor solution.

Also in the case of using the laminated type separator, lithium can move in an ionic state between the positive electrode 21 and the negative electrode 22, so that the same effect can be obtained. In this case, in particular, as described above, the swelling of the secondary battery is suppressed, so that a higher effect can be obtained.

An electrolytic solution which was a liquid electrolyte was used. However, although not specifically illustrated in the drawing, an electrolyte layer that is a gel-like electrolyte may be used.

In the battery element 20 using the electrolyte layer, the positive electrode 21 and the negative electrode 22 are wound while facing each other with the separator 23 and the electrolyte layer interposed therebetween. The electrolyte layer is interposed between the positive electrode 21 and the separator 23, and is interposed between the negative electrode 22 and the separator 23.

Specifically, the electrolyte layer contains an electrolytic solution and a polymer compound, and the electrolytic solution is held by the polymer compound. This is because leakage of the electrolytic solution is prevented. The configuration of the electrolytic solution is as described above. The polymer compound contains polyvinylidene fluoride or the like. In the case of forming an electrolyte layer, after a precursor solution containing an electrolytic solution, a polymer compound, and a solvent is prepared, the precursor solution is applied to one surface or both surfaces of the positive electrode 21, and the precursor solution is applied to one surface or both surfaces of the negative electrode 22.

Also in the case of using the electrolyte layer, lithium can move in an ionic state between the positive electrode 21 and the negative electrode 22 with the electrolyte layer interposed therebetween, so that the same effect can be obtained. In this case, in particular, as described above, leakage of the electrolytic solution is prevented, so that a higher effect can be obtained.

### EXAMPLES

Description is given on examples of the present technology according to an embodiment.

### Examples 1 and 2 and Comparative Examples 1 to 4

As described below, after a secondary battery was produced, battery characteristics of the secondary battery were evaluated. Here, in order to simply evaluate the battery characteristics, a secondary battery for a test described later was produced, and then the battery characteristics were evaluated using the secondary battery for a test.

### [Production of Secondary Battery]

Hereinafter, the configuration of the secondary battery for a test will be briefly described, and then a procedure for producing the secondary battery for a test will be described.

### (Configuration of Secondary Battery)

FIG. 8 illustrates the sectional configuration of the secondary battery for a test, and the secondary battery for a test is a so-called coin type lithium ion secondary battery.

As illustrated in FIG. 8, the secondary battery includes a test electrode 61, a counter electrode 62, a separator 63, an exterior cup 64, an exterior can 65, a gasket 66, and an electrolytic solution (not illustrated).

The test electrode 61 is accommodated in the exterior cup 64, and the counter electrode 62 is accommodated in the exterior can 65. The test electrode 61 and the counter electrode 62 are laminated on each other with the separator 63 interposed therebetween, and each of the test electrode 61, the counter electrode 62, and the separator 63 is impregnated with the electrolytic solution. Since the exterior cup 64 and the exterior can 65 are crimped to each other with the gasket 66 interposed therebetween, the test electrode 61, the counter electrode 62, and the separator 63 are enclosed inside the exterior cup 64 and the exterior can 65.

### (Procedure for Producing Secondary Battery)

The secondary battery illustrated in FIG. 8 was produced by the procedure described later.

### (Production of Test Electrode)

First, a plurality of central portions (lithium composite oxides) were prepared. As the lithium composite oxide, LiNi_{0.96}Co_{0.10}Mn_{0.04}O₂ (LNCM) and LiNi_{0.98}Co_{0.10}Al_{0.02}O₂ (LNCA) were used. The content ratio (mol %) of the lithium composite oxide is as shown in Table 1.

Subsequently, a powdery boron-oxygen-containing material (powdery lithium metaborate) was supplied to the surface of each of the plurality of central portions. As a result, since the surface of each of the plurality of central portions was dry-coated with the powdery boron-oxygen-containing material, a lower covering portion containing the boron-oxygen-containing material was formed. In this case, as shown in Table 1, the content (wt %) of the lower covering portion in the positive electrode active material particle was set.

Subsequently, a powdery carbon-oxygen-containing material (powdery lithium carbonate) was supplied to the surface of each of the plurality of central portions on which the lower covering portion was formed. As a result, since the surface of the lower covering portion was dry-coated with the powdery carbon-oxygen-containing material, a precursor covering portion containing the carbon-oxygen-containing material was formed. Therefore, a plurality of precursor particles each including the central portion, the lower covering portion, and the precursor covering portion were formed.

Subsequently, a positive electrode mixture was prepared by mixing 95.5 parts by mass of the plurality of precursor particles, 2.5 parts by mass of a positive electrode binder (polyvinylidene fluoride), 1.9 parts by mass of a positive electrode conductive agent (carbon black), and 0.1 parts by mass of a dispersant (polyvinylpyrrolidone) together. Subsequently, the positive electrode mixture was put into a solvent (N-methyl-2-pyrrolidone as an organic solvent), and then the solvent was stirred to prepare a paste-like positive electrode mixture slurry.

Subsequently, the positive electrode mixture slurry was applied to one surface of a positive electrode current collector (aluminum foil, thickness=15 μm) and then the positive electrode mixture slurry was dried (drying temperature=100° C., drying time=15 minutes) to form a precursor layer (thickness=50 μm).

Subsequently, the positive electrode current collector on which the precursor layer was formed was stored (storage time=30 minutes) in a humidified environment (temperature=30° C., humidity=50%) using an environmental tester. As a result, moisture adhered to the surface of the precursor layer.

Subsequently, the positive electrode current collector on which the precursor layer was formed was punched into a disk shape (diameter=16.5 mm).

Finally, as described later, after the secondary battery was assembled using the positive electrode current collector on which the precursor layer was formed, a stabilization treatment was performed using the assembled secondary battery. As a result, lithium carbonate was converted into lithium fluoride using the reactions represented by Formulas (11) and (12), and thus the precursor covering portion was converted into the upper covering portion. In this case, as shown in Table 1, the content (wt %) of the upper covering portion in the positive electrode active material particle was set.

Therefore, since the covering portion including the lower covering portion and the upper covering portion was formed on the surface of each of the plurality of central portions, the plurality of precursor particles were converted into the plurality of positive electrode active material particles. As a result, the plurality of positive electrode active material particles each including the central portion and the covering portion were formed, so that the positive electrode active material layer containing the plurality of positive electrode active material particles was formed. Thus, the test electrode 61 was produced.

In the case of producing the test electrode 61, the configuration of the positive electrode active material particle was changed using the procedure described below.

First, the content (wt %) of the lower covering portion in the positive electrode active material particle was adjusted by changing the supply amount of the boron-oxygen-containing material to be supplied to the surface of the central portion. As a result, the adhesion amount of the boron-oxygen-containing material to the surface of the central portion changed, and thus the thickness of the lower covering portion changed.

Second, the content (wt %) of the upper covering portion in the positive electrode active material particle was adjusted by changing the supply amount of the carbon-oxygen-containing material to be supplied to the surface of the lower covering portion. As a result, the adhesion amount of the carbon-oxygen-containing material to the surface of the central portion changed, and thus the thickness of the upper covering portion changed.

Third, the content (wt %) of the upper covering portion in the positive electrode active material particle was adjusted by changing storage conditions (humidity and storage time) when the positive electrode current collector on which the precursor layer was formed was stored in a humidified environment. As a result, since the degrees of progress of the reactions represented by Formulas (11) and (12) changed in response to the change in the adhesion amount of moisture to the surface of the precursor layer, the thickness of the upper covering portion changed.

### (Production of Counter Electrode)

A lithium metal plate was punched into a disk shape (diameter=17 mm). Thereby, the counter electrode 62 was produced.

### (Preparation of Electrolytic Solution)

An electrolyte salt (lithium hexafluorophosphate as a fluorine-containing lithium salt) was put into a solvent (ethylene carbonate which is cyclic carbonic acid ester and dimethyl carbonate which is a chain carbonic acid ester), and the solvent was stirred. The mixing ratio (weight ratio) of solvent was set to ethylene carbonate:dimethyl carbonate=30:70. The content of the electrolyte salt was set to 1.4 mol/l (=1 mol/dm³) with respect to the solvent. Thereby, the electrolytic solution was prepared.

### (Assembly of Assembled Secondary Battery)

First, the positive electrode current collector on which the precursor layer was formed was accommodated in the exterior cup 64, and the counter electrode 62 was accommodated in the exterior can 65. Subsequently, the positive electrode current collector on which the precursor layer was formed and the counter electrode 62 were laminated on each other with the separator 63 (disk-shaped polyethylene film having a diameter of 17.5 μm), which was impregnated with the electrolytic solution, interposed therebetween. In this case, the precursor layer and the counter electrode 62 faced to each other with the separator 63 interposed therebetween.

Subsequently, in a state where the positive electrode current collector on which the precursor layer was formed and the counter electrode 62 were laminated on each other with the separator 63 interposed therebetween, the exterior cup 64 and the exterior can 65 were crimped to each other with the gasket 66 interposed therebetween. As a result, the positive electrode current collector on which the precursor layer was formed and the counter electrode 62 were enclosed inside the exterior cup 64 and the exterior can 65, so that the secondary battery was assembled.

Finally, the assembled secondary battery was allowed to stand still (standing time=10 hours). As a result, a part of the electrolytic solution impregnated in the separator 63 penetrated into the test electrode 61.

### (Stabilization Treatment of Assembled Secondary Battery)

First, the assembled secondary battery was charged in the atmosphere (temperature=23° C., humidity=30%) which is a normal-temperature, normal-humidity environment. In this case, constant current charging was performed at a current of 0.1 C until the voltage reached 4.45 V and then constant voltage charging was performed at a voltage of 4.45 V until the current reached 0.01 C. 0.1 C is a current value at which the battery capacity (theoretical capacity) can be discharged in 10 hours, and 0.01 C is a current value at which the battery capacity can be discharged in 100 hours.

Subsequently, the assembled secondary battery in a charged state was stored (storage time=24 hours) in an oven (temperature=60° C.) in a high-temperature environment.

Thereby, as described above, since the covering portion including the lower covering portion and the upper covering portion was formed on the surface of each of the plurality of central portions, the plurality of positive electrode active material particles were formed. Therefore, since the positive electrode active material layer containing the plurality of positive electrode active material particles was formed, the test electrode 61 was produced.

Finally, the assembled secondary battery in a charged state was discharged in the atmosphere which is a normal-temperature, normal-humidity environment. In this case, constant current discharging was performed at a current of 0.1 C until the voltage reached 2.50 V.

Thus, a secondary battery was completed (Examples 1 and 2).

### [Production of Secondary Battery for Comparison]

For comparison, another secondary battery was also produced using the procedure described below.

First, a secondary battery was produced by the same procedure, except that the covering portion including only the upper covering portion was formed since the lower covering portion was not formed (Comparative Examples 1 and 2).

Second, as described below, a secondary battery was produced by the same procedure, except that the plurality of positive electrode active material particles were formed using the procedure disclosed in Japanese Patent Application Laid-Open No. 2022-525463 described above (Comparative Example 3).

In the case of forming the plurality of positive electrode active material particles, first, 120 parts by mass of the plurality of central portions (LNCM) and 100 parts by mass of distilled water (temperature=25° C.) were mixed together to wash the plurality of central portions using the distilled water (washing time=15 minutes), and then the plurality of central portions were dried (drying temperature=130° C.).

Subsequently, 100 parts by mass of the plurality of central portions, 0.1 parts by mass of polyvinylidene fluoride (PVDF), and 0.9 parts by mass of aluminum hydroxide (Al(OH)₃) were mixed together to obtain a mixture.

Finally, the mixture was heated (heating temperature=600° C.) to form a covering portion containing polyvinylidene fluoride and aluminum hydroxide on the surface of each of the plurality of central portions. As a result, the plurality of positive electrode active material particles each including the central portion and the covering portion were formed.

Third, as described below, a secondary battery was produced by the same procedure, except that the plurality of positive electrode active material particles were formed using the procedure disclosed in Japanese Patent Application Laid-Open No. 2013-062026 described above (Comparative Example 4).

In the case of forming the plurality of positive electrode active material particles, the same procedure as the procedure of Example 1 was used except that a precursor layer was formed using only a plurality of central portions (LNCM) without using a boron-oxygen-containing material and a carbon-oxygen-containing material, and then a covering portion was formed on the surface of each of the plurality of central portions using the stabilization treatment of the assembled secondary battery. In this case, since a covering portion containing a decomposition product of the electrolyte salt (lithium hexafluorophosphate) contained in the electrolytic solution was formed instead of forming the upper covering portion and the lower covering portion, the plurality of positive electrode active material particles each including the central portion and the covering portion were formed. The covering portion is a coating film formed on the surface of each of the plurality of central portions in the stabilization treatment.

Here, the results of examining the content ratio (mol %) after completion of the secondary battery are as shown in Table 1.

After completion of the secondary battery, in the depth analysis of the test electrode 61 using TOF-SIMS, the results of examining whether or not each of the three kinds of physical property conditions is satisfied with respect to the physical properties of the test electrode 61 are as shown in Table 1.

### [Evaluation on Battery Characteristics]

Heat resistance characteristics were evaluated as battery characteristics by the procedure described later, and the results shown in Table 1 were obtained.

In the case of evaluating the heat resistance characteristics, as described below, an environmental temperature (° C.), which is an index for evaluating the heat resistance characteristics, was examined by performing a thermal stability evaluation test using the secondary battery.

First, the secondary battery was charged in the atmosphere (temperature=23° C., humidity=30%) which is a normal-temperature, normal-humidity environment. In this case, constant current charging was performed at a current of 0.1 C until the voltage reached 4.25 V and then constant voltage charging was performed at a voltage of 4.25 V until the current reached 0.01 C.

Subsequently, the test electrode 61 and the electrolytic solution were recovered by disassembling the secondary battery in a charged state. Subsequently, the positive electrode current collector was peeled from the positive electrode active material layer, and then a sample (the positive electrode active material layer and the electrolytic solution) was enclosed in an aluminum sample pan for thermal analysis.

Finally, the sample pan was attached to a differential scanning calorimeter (DSC), and then the sample was thermally analyzed using the differential scanning calorimeter to specify the environmental temperature (° C.) when the maximum exothermic peak was detected. In this case, a differential scanning calorimeter DSC6300 manufactured by Hitachi High-Technologies Corporation was used as a differential scanning calorimeter, and the temperature raising rate was set to 10° C./min.

When the lithium composite oxide as a positive electrode active material is heated inside the differential scanning calorimeter, the lithium composite oxide releases heat due to the collapse of the crystal structure. As a result, the maximum exothermic peak is a peak detected due to heat released from the lithium composite oxide. Therefore, the environmental temperature when the maximum exothermic peak is detected represents the thermal stability of the lithium composite oxide, that is, how many degrees the crystal structure can withstand when the lithium composite oxide is heated.

Therefore, since the thermal stability of the lithium composite oxide increases as the environmental temperature increases, the temperature of the test electrode 61 is less likely to increase excessively at the time of overcharge, heating of the secondary battery, occurrence of internal short circuit, and the like. On the other hand, since the thermal stability of the lithium composite oxide decreases as the environmental temperature decreases, the temperature of the test electrode 61 tends to increase excessively at the time of overcharge, heating of the secondary battery, occurrence of internal short circuit, and the like.

TABLE 1

| | Positive electrode active material particle | | | | | | | | | |
|---|---|---|---|---|---|---|---|---|---|---|
| | Central portion | | Covering portion | | | | | | | |
| | Lithium | Content | Upper | | Lower | | | | | Environmental |
| | composite | ratio | covering | Content | covering | Content | Physical property condition | | | temperature |
| | oxide | (mol %) | portion | (wt %) | portion | (wt %) | First | Second | Third | (° C.) |
| Example 1 | LNCM | 86 | LiF | 0.5 | LiBO₂ | 0.5 | Satisfied | Satisfied | Satisfied | 235 |
| Example 2 | LNCA | 88 | LiF | 0.7 | LiBO₂ | 0.3 | Satisfied | Satisfied | Satisfied | 237 |
| Comparative | LNCM | 86 | LiF | 0.5 | — | — | Satisfied | Not | Not | 213 |
| Example 1 | | | | | | | | satisfied | satisfied | |
| Comparative | LNCA | 88 | LiF | 0.5 | — | — | Satisfied | Not | Not | 215 |
| Example 2 | | | | | | | | satisfied | satisfied | |

| | | | | | | | |
|---|---|---|---|---|---|---|---|
| Comparative | LNCM | 86 | Covering portion = | Satisfied | Not | Not | 217 |
| Example 3 | | | PVDF + Al(OH)₃ | | satisfied | satisfied | |
| Comparative | LNCM | 86 | Covering portion = | Satisfied | Not | Not | 218 |
| Example 4 | | | Decomposition product | | satisfied | satisfied | |
| | | | of LiPF₆ | | | | |

As shown in Table 1, when the test electrode 61 contained a lithium composite oxide and the content ratio of the lithium composite oxide was 80 mol % or more, the environmental temperature varied according to the physical properties of the test electrode 61.

Specifically, when all of the three kinds of physical property conditions were not satisfied with respect to the physical properties of the test electrode 61 (Comparative Examples 1 to 4), the environmental temperature decreased. On the other hand, when all of the three kinds of physical property conditions were satisfied with respect to the physical properties of the test electrode 61 (Examples 1 and 2), the environmental temperature increased.

In particular, when all of the three kinds of physical property conditions were satisfied with respect to the physical properties of the test electrode 61 (Examples 1 and 2), the tendency described below was obtained.

First, when the covering portion included the upper covering portion and the lower covering portion, the environmental temperature increased. In this case, when the upper covering portion contained lithium fluoride and the lower covering portion contained lithium metaborate, the environmental temperature sufficiently increased.

Second, the environmental temperature increased without depending on the composition of the lithium composite oxide. In this case, the lithium composite oxide contained other elements as constituent elements, the environmental temperature sufficiently increased.

### Examples 3 to 5 and Comparative Examples 5 and 6

As shown in Table 2, a secondary battery was produced in substantially the same procedure except that a boron-fluorine-containing material (lithium tetrafluoroborate) was added to the electrolytic solution, and then the battery characteristics were evaluated.

In this case, a boron-fluorine-containing material was added to the electrolytic solution, and then the electrolytic solution was stirred. The content (wt %) of the boron-fluorine-containing material in the electrolytic solution is as shown in Table 2.

TABLE 2

| | Positive electrode active material particle | | | | | | Electrolytic solution | | | | | |
|---|---|---|---|---|---|---|---|---|---|---|---|---|
| | Central portion | | Covering portion | | | | Boron- | | | | | Environ- |
| | Lithium | Content | Upper | | Lower | | fluorine- | | | | | mental |
| | composite | ratio | covering | Content | covering | Content | containing | Content | Physical property condition | | | temperature |
| | oxide | (mol %) | portion | (wt %) | portion | (wt %) | material | (wt %) | First | Second | Third | (° C.) |
| Example 3 | LNCM | 86 | LiF | 0.5 | LiBO₂ | 0.5 | LiBF₄ | 0.5 | Satisfied | Satisfied | Satisfied | 238 |
| Example 4 | LNCM | 86 | LiF | 0.8 | LiBO₂ | 0.35 | LiBF₄ | 0.5 | Satisfied | Satisfied | Satisfied | 239 |
| Example 5 | LNCA | 88 | LiF | 0.7 | LiBO₂ | 0.3 | LiBF₄ | 0.5 | Satisfied | Satisfied | Satisfied | 238 |
| Comparative | LNCM | 86 | LiF | 0.5 | — | — | LiBF₄ | 0.5 | Satisfied | Not | Not | 215 |
| Example 5 | | | | | | | | | | satisfied | satisfied | |
| Comparative | LNCA | 88 | LiF | 0.5 | — | — | LiBF₄ | 0.5 | Satisfied | Not | Not | 220 |
| Example 6 | | | | | | | | | | satisfied | satisfied | |

Also in a case where the electrolytic solution contained the boron-fluorine-containing material (Table 2), the same results as in a case where the electrolytic solution did not contain the boron-fluorine-containing material (Table 1) were obtained. That is, when all of the three kinds of physical property conditions were satisfied with respect to the physical properties of the test electrode 61 (Examples 3 to 5), the environmental temperature increased as compared with a case where all of the three kinds of physical property conditions were not satisfied with respect to the physical properties of the test electrode 61 (Comparative Examples 5 and 6).

In particular, in a case where the electrolytic solution contained the boron-fluorine-containing material (Example 3), the environmental temperature further increased as compared with a case where the electrolytic solution did not contain the boron-fluorine-containing material (Example 1).

From the results shown in Tables 1 and 2, when the positive electrode active material layer 21B of the test electrode 61 contained the plurality of positive electrode active material particles 210, the positive electrode active material particles 210 each increased the central portion 211 and the covering portion 212, the central portion 211 contained a lithium composite oxide having a crystal structure of a layered rock salt type, the content ratio C of the lithium composite oxide was 80 mol % or more, the electrolyte salt of the electrolytic solution contained a fluorine-containing lithium salt, and all of the three kinds of physical property conditions were satisfied with respect to the physical properties of the test electrode 61, the environmental temperature increased. Therefore, when the lithium composite oxide having a content ratio C of 80 mol % or more was used, the heat resistance characteristics were improved, so that excellent safety could be obtained.

Although the present technology has been described above with reference to the embodiment and the examples, the configurations of the present technology are not limited to the configurations described in the embodiment and the examples, and are therefore modifiable in a variety of ways.

For example, a case where the battery structure of the secondary battery is a laminate film type and a coin type has been described. However, the battery structure of the secondary battery is not particularly limited, and thus may be a cylindrical type, a square type, a button type, and the like.

A case where the element structure of the battery element is a winding type has been described. However, the element structure of the battery element is not particularly limited, and may be a laminated type, a zigzag folded type, or the like. In the laminated type, the positive electrode and the negative electrode are alternately laminated with the separator interposed therebetween, and in the zigzag folded type, the positive electrode and the negative electrode are folded in a zigzag manner while facing each other with the separator interposed therebetween.

A case where the electrode reactant is lithium has been described, but the electrode reactant is not particularly limited. Specifically, as described above, the electrode reactant may be other alkali metals such as sodium and potassium, or alkaline earth metals such as beryllium, magnesium, and calcium. In addition, the electrode reactant may be another light metal such as aluminum.

Since the effects described in the present specification are merely examples, the effects of the present technology are not limited to the effects described in the present specification. Therefore, other effects regarding the present technology may be obtained.

The present technology may also take the following configurations according to an embodiment.

<1>

A secondary battery including:
a positive electrode including a positive electrode active material layer;
a negative electrode; and
an electrolytic solution containing an electrolyte salt,
wherein the positive electrode active material layer contains a plurality of positive electrode active material particles,
the positive electrode active material particles each include
   a central portion containing a lithium composite oxide, and
   a covering portion provided on a surface of the central portion,
the lithium composite oxide has a crystal structure of a layered rock salt type and contains lithium, nickel, and other elements as constituent elements,
the covering portion contains lithium, fluorine, boron, and oxygen as constituent elements,
the electrolyte salt contains a fluorine-containing lithium salt,
when a sum of a content of the nickel in the lithium composite oxide and a content of the other elements in the lithium composite oxide is taken as 100 parts by mol, the content of the nickel in the lithium composite oxide is 80 parts by mol or more and 100 parts by mol or less,
a first negative secondary ion derived from LiF₂⁻ and a second negative secondary ion derived from BO₂⁻ are detected in analysis in a depth direction of the positive electrode active material layer using time-of-flight secondary ion mass spectrometry,
a change in ionic strength of the first negative secondary ion in the depth direction has a first peak, and a change in ionic strength of the second negative secondary ion in the depth direction has a second peak, and
the second peak is located on a deeper side than the first peak in the depth direction.
   <2>

The secondary battery according to <1>, in which
the covering portion includes, in order from a side farther from the central portion,
a first covering portion containing lithium and fluorine as constituent elements, and
a second covering portion containing lithium, boron, and oxygen as constituent elements.
   <3>

The secondary battery according to <2>, in which
the first covering portion contains lithium fluoride (LiF), and
the second covering portion contains lithium metaborate (LiBO₂).
   <4>

The secondary battery according to any one of <1> to <3>, in which the other elements include at least one of cobalt, aluminum, manganese, zirconium, titanium, molybdenum, tantalum, chromium, niobium, iron, copper, zinc, vanadium, magnesium, tungsten, sulfur, strontium, boron, sodium, and fluorine.

<5>

The secondary battery according to any one of <1> to <4>, in which the fluorine-containing lithium salt contains at least one of lithium hexafluorophosphate (LiPF₆) and lithium bis(fluorosulfonyl)imide (LiN(FSO₂)₂).

<6>

The secondary battery according to any one of <1> to <5>, in which the electrolytic solution further contains a boron-fluorine-containing material.

<7>

The secondary battery according to <6>, in which the boron-fluorine-containing material contains at least one of lithium tetrafluoroborate (LiBF₄) and lithium difluoro(oxalato)borate (LiBF₂ (C₂O₄)).

<8>

The secondary battery according to any one of <1> to <7>, which is a lithium ion secondary battery.

It should be understood that various changes and modifications to the embodiments described herein will be apparent to those skilled in the art. Such changes and modifications can be made without departing from the spirit and scope the present subject matter and without diminishing its intended advantages. It is therefore intended that such changes and modifications be covered by the appended claims.

What is claimed is:

1. A secondary battery comprising:
a positive electrode including a positive electrode active material layer;
a negative electrode; and
an electrolytic solution including an electrolyte salt,
wherein the positive electrode active material layer includes a plurality of positive electrode active material particles,
the positive electrode active material particles each include
a central portion including a lithium composite oxide, and
a covering portion provided on a surface of the central portion,
the lithium composite oxide has a crystal structure of a layered rock salt type and includes lithium, nickel, and other elements as constituent elements,
the covering portion includes lithium, fluorine, boron, and oxygen as constituent elements,
the electrolyte salt includes a fluorine-containing lithium salt,
a sum of a content of the nickel in the lithium composite oxide and a content of the other elements in the lithium composite oxide is taken as 100 parts by mol, the content of the nickel in the lithium composite oxide is 80 parts by mol or more and 100 parts by mol or less,
a first negative secondary ion derived from LiF₂⁻ and a second negative secondary ion derived from BO₂⁻ are detected in analysis in a depth direction of the positive electrode active material layer using time-of-flight secondary ion mass spectrometry,
a change in ionic strength of the first negative secondary ion in the depth direction has a first peak, and a change in ionic strength of the second negative secondary ion in the depth direction has a second peak, and
the second peak is located on a deeper side than the first peak in the depth direction.

2. The secondary battery according to claim 1, wherein
the covering portion includes, in order from a side farther from the central portion,
a first covering portion including lithium and fluorine as constituent elements, and
a second covering portion including lithium, boron, and oxygen as constituent elements.

3. The secondary battery according to claim 2, wherein
the first covering portion includes lithium fluoride (LiF), and
the second covering portion includes lithium metaborate (LiBO₂).

4. The secondary battery according to claim 1, wherein the other elements include at least one of cobalt, aluminum, manganese, zirconium, titanium, molybdenum, tantalum, chromium, niobium, iron, copper, zinc, vanadium, magnesium, tungsten, sulfur, strontium, boron, sodium, and fluorine.

5. The secondary battery according to claim 1, wherein the fluorine-containing lithium salt includes at least one of lithium hexafluorophosphate (LiPF₆) and lithium bis(fluorosulfonyl)imide (LiN(FSO₂)₂).

6. The secondary battery according to claim 1, wherein the electrolytic solution further includes a boron-fluorine-containing material.

7. The secondary battery according to claim 6, wherein the boron-fluorine-containing material includes at least one of lithium tetrafluoroborate (LiBF₄) and lithium difluoro (oxalato) borate (LiBF₂ (C₂O₄)).

8. The secondary battery according to claim 1, which is a lithium ion secondary battery.
